(19) United States
(12) Patent Application Publication
(10) Pub. No.: US 2021/0079534 A1
(43) Pub. Date: Mar. 18, 2021

(54) METHOD, CELL, AND ELECTROLYTE FOR DINITROGEN CONVERSION

(71) Applicant: MONASH UNIVERSITY, Clayton (AU)

(72) Inventors: Douglas MACFARLANE, Clayton (AU); Mega KAR, Clayton (AU); Jacinta BAKKER, Clayton (AU); Ciaran James MCDONNELL-WORTH, Clayton (AU); Colin Suk Mo KANG, Clayton (AU); Fengling ZHOU, Clayton (AU); Xinyi ZHANG, Clayton (AU); Bryan Harry Rahmat SURYANTO, Clayton (AU)

(21) Appl. No.: 16/633,557

(22) PCT Filed: Jul. 26, 2018
(86) PCT No.: PCT/AU2018/000122

§ 371 Date: Jan. 23, 2020

(30) Foreign Application Priority Data
Jul. 27, 2017 (AU) 2017902960
Feb. 7, 2018 (AU) 2018900370

(51) Int. Cl. C25B 1/00; C25B 9/08; C01C 1/04; C25B 11/03; C25B 11/04

(52) U.S. Cl. CPC C25B 1/00; C25B 9/08; C25B 11/0405; C25B 11/035; C01C 1/0405

(57) ABSTRACT

The present invention relates to a method, and a cell for carrying out the method for the electrochemical reduction of dinitrogen to ammonia. The method comprises the steps of: (1) contacting a cathodic working electrode comprising a nanostructured catalyst with an electrolyte comprising (a) one or more liquid salts optionally in combination with (b) one or more organic solvents having low viscosity and supporting high ionic conductivity, and (2) introducing dinitrogen and a source of hydrogen to the electrolyte, wherein the dinitrogen is reduced to ammonia at the cathodic working electrode.

### FIELD OF INVENTION

The present invention relates to an electrochemical apparatus and method for the conversion of dinitrogen (N₂) into ammonia.

In one form, the invention relates to the cathodic reduction of dinitrogen.

In one particular aspect, the present invention is suitable for use in industrial production of ammonia.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Ammonia production is a highly energy intensive process, consuming 1-3% of the world electrical energy and about 5% of the world natural gas production. World production is currently around 200 million tonnes annually, reflecting the vast need for this chemical in agriculture, pharmaceutical production and many other industrial processes.

Ammonia is also being considered as a carbon-free solar energy storage material, due to its useful characteristics as a chemical energy carrier. Compared to other chemicals that could be used to store solar energy (such as hydrogen), ammonia is safe, eco-friendly and, most importantly, produces no CO₂ emissions. Once stored in this form, the energy is readily recovered via the ammonia fuel cell.

For more than a hundred years, ammonia has been produced from dinitrogen and hydrogen in the presence of an iron based catalyst at high pressures and high temperatures according to the following nitrogen reduction reaction (NRR):

$${N}_{2 ( g )} + 3 {H}_{2 ( g )} {{⇌}^{ Iron \text{-} based catalyst }}_{15 \text{-} 30 MPa ; 430 \text{-} {480}^{°} C .} 2 {NH}_{3 ( g )} \qquad Equation 1$$

This process, known as the Haber-Bosch process has been of key importance in producing the inexpensive fertilisers that have supported the large global population growth over the past century. The Haber-Bosch process uses very high temperatures and pressures, and requires substantial amounts of energy in the form of natural gas, oil or coal for the production of the required hydrogen. Despite these drawbacks, the Haber Bosch process remains the predominant method for industrial ammonia synthesis.

Given the need to feed a growing world population, whilst simultaneously reducing global carbon emissions, it is highly desirable to break the link between industrial nitrogen-based fertiliser production and the use of fossil fuels. Therefore, there is intense interest in alternative pathways for ammonia synthesis, particularly those that have a reduced carbon footprint.

In recent years, electrochemical conversion of dinitrogen to ammonia has attracted particular interest because it can be economically feasible, easily scalable, would operate at ambient condition and could be coupled to renewable energy sources such as wind, hydro or solar. The electrochemical reduction process involves dinitrogen gas as a starting material, which is reduced to form ammonia, and uses various aqueous electrolytes or H₂ gas as a proton (H⁺) source.

In the past, it has been hypothesised that the electrochemical reduction of dinitrogen largely depends on the structure, components, and surface morphology of the electrocatalyst. (van der Ham et al., Chemical Society Reviews 43, 5183-5191 (2014)). In general, prior art NRR studies conducted at ambient temperature and pressure have suffered the drawbacks of low Faradaic efficiency (FE<10%) and/or low ammonia yield rate (10⁻¹⁴ to 10⁻¹¹ mol s⁻¹cm⁻²). One problem lies in the low selectivity for NRR from hydrogen evolution reaction (HER) due to the competing proton reduction to hydrogen (H⁺+2e⁻↔H₂) such that the efficiency of electrons contributing to the dinitrogen reduction reaction is low. In principal, the efficiency can be improved by (i) limiting the proton transfer rate by reducing the proton concentration in bulk solution and/or increasing the barrier for the proton to the electrode surface and/or (ii) limiting the electron transfer by lowering the electron stream. (Singh et al., ACS Catalysis, 2017, 7, 706-709). In addition, although it remains debatable, the standard reduction potential of N₂ is close (˜350 mV) to that for HER. Therefore, the H⁺ adsorption is greatly favoured due to the generation of an electric field during electrochemical reduction, thus rendering NRR challenging.

One effective way of limiting the proton rate is to use aprotic electrolytes such as aprotic liquid salts, which not only significantly increases the dinitrogen solubility but also reduce the protons present in the electrolytes. (Armand et al., Nat Mater, 2009, 8, 621-629). Introducing aprotic liquid salts such as ([P_{6,6,6,14}][eFAP] and [C₄mpyr][eFAP]) with high dinitrogen solubility can significantly increase the selectivity for dinitrogen reduction. These salts, however, have quite high viscosities (400 mPa·s and 204 mPa·s at 298K) and low conductivities, which limits the mass transfer and results in a low current density.

One of the most notable early attempts to carry out electrochemical NRR at ambient temperature and pressure was conducted by Kordali et al., using a Pt electrode as a cathode. The study achieved an ammonia yield rate of 3.12×10⁻¹² mol s⁻¹ cm⁻², with a FE of 0.28% at 20° C. The reason for the low FE was the high catalytic activity of Pt electrode for HER. Therefore, a number of more recent studies have been directed towards the development of novel advanced catalysts for NRR at ambient temperature and pressure based on Sabatier's principle to disfavour H⁺ adsorption. Materials that exhibit weak adsorption for H⁺ (ΔG_{M-H}>0) have been reported to yield relatively improved NRR FE and ammonia yield rates. For example, Bao et al. demonstrated the use of high-index faceted gold nanorods (ΔG_{M-H}>0.3 eV), as NRR catalyst, delivering a maximum ammonia yield rate of 2.69×10⁻¹¹ mol s⁻¹ cm⁻² with a FE of 4.00%. (D. Bao et al., Advanced Materials, 2017, 29, 1604799.)

Accordingly, there is an ongoing need to improve the process for electrochemical reduction of dinitrogen to ammonia in terms of improved yield and improved FE.

### SUMMARY OF INVENTION

An object of the present invention is to provide an improved electrochemical process for production of ammonia.

Another object of the present invention is to provide an improved method for cathodic dinitrogen reduction.

A further object of the present invention is to alleviate at least one disadvantage associated with prior art processes for ammonia production by dinitrogen reduction.

It is an object of the embodiments described herein to overcome or alleviate at least one of the above noted drawbacks of related art systems or to at least provide a useful alternative to related art systems.

In a first aspect of embodiments of the present invention there is provided a method for the electrochemical reduction of dinitrogen to ammonia, the method comprising the steps of:
(1) contacting a cathodic working electrode comprising a nanostructured catalyst with an electrolyte comprising (a) one or more liquid salts preferably in combination with (b) one or more organic solvents having low viscosity and supporting high ionic conductivity, and
(2) introducing dinitrogen and a source of hydrogen to the electrolyte,

wherein the dinitrogen is reduced to ammonia at the cathodic working electrode.

Where used herein the term ‘low viscosity’ refers to viscosity values between 0.6 and 40.0 mPa/S measured by the falling ball technique at 25° C. Furthermore, where used herein the term ‘low viscosity’ refers to viscosity values between 0.4 and 25.0 mPa/S measured by the falling ball technique at 50° C.

As suitable solvents for use with the present invention do not have high ion conductivity on their own, the term ‘supporting high conductivity’ refers to the combination of solvent with the liquid salt.

Where used herein the term ‘low ionic conductivity’ refers to a salt or salt/solvent mixture having conductivity values between 1×10⁻⁴ and 1×10⁻² S/cm measured by AC impedance spectroscopy at 25° C. Where used herein the term ‘high ionic conductivity’ refers to a salt or salt/solvent mixture having conductivity values between 2×10⁻⁴ and 4×10⁻² S/cm measured by AC impedance spectroscopy at 50° C. Hewlett Packard 4284 LCR meter was used to measure conductivity by using AC impedance spectroscopy over a range of 20 Hz to 1 MHz.

Preferably, the one or more liquid salts is selected from the one or more liquid salts described herein below.

The method may additionally include a step (3) comprising collecting ammonia generated at the cathodic working electrode, separating the ammonia from other liquids and gases present by using a separate trap or separation unit.

In a second aspect of embodiments described herein there is provided a cell for electrochemical reduction of dinitrogen to ammonia, the cell comprising:
a cathodic working electrode comprising a nanostructured catalyst for reduction of dinitrogen,
a counter electrode, and
an electrolyte comprising (a) one or more liquid salts according to the present invention, optionally in combination with (b) one or more organic solvents having low viscosity and supporting high ionic conductivity,

wherein dinitrogen introduced to the cell is reduced to ammonia at the cathodic working electrode in the presence of a source of hydrogen.

The counter electrode may be placed in the same electrolyte as the cathodic working electrode or alternatively, it may be separated by some means such as an electrolyte membrane or separator material. In another embodiment the counter electrode may be located in a compartment, which optionally contains a different electrolyte medium, such as an aqueous solution.

The counter electrode reaction may comprise water oxidation or another advantageous oxidation reaction well known to the person skilled in the art such as sulphite oxidation.

In a further aspect of embodiments described herein there is provided a cell for electrochemical reduction of dinitrogen to ammonia, the cell comprising:
a cathodic working electrode comprising a nanostructured catalyst for reduction of dinitrogen,
a counter electrode, and
an electrolyte comprising one or more liquid salts in contact with the working electrode, wherein the liquid salt is formed by a combination of:
(i) a cation selected from the group comprising ammonium, pyrrolidinium, phosphonium, and imidazolium cations; and
(ii) an anion selected from the group comprising fluorinated borate, fluorinated phosphate, fluorinated sulphonate, fluorinated imide or fluorinated carbonate anions.

In a further aspect of embodiments described herein there is provided a cell for electrochemical reduction of dinitrogen to ammonia, the cell comprising:
a cathodic working electrode comprising a nanostructured catalyst for reduction of dinitrogen,
a counter electrode, and
an electrolyte comprising one or more liquid salts in contact with the working electrode, wherein the liquid salt is formed by a combination of:
(a) a cation selected from the group comprising: 1-(3,3,4,4,5,5,6,6,7,7,8,8,8-tridecafluorooctyl)-2,3-dimethylimidazolium, 1-(3,3,4,4,5,5,6,6,7,7,8,8,8-tridecafluorooctyl)-3-methylimidazolium, 1-ethyl-3-methylimidazolium, 1-butyl-methyl pyrrolidinium, trihexyl tetradecylphosphonium, tributyl-(4,4,5,5,6,6,7,7,8,8,9,9,10,10,11,11,11-heptadecafluoro undecyl)-phosphonium, tributyl-(3,3,4,4,5,5,6,6,7,7,8,8,8-tridecafluoroctyl) phosphonium, N-ethyl-N,N,N-tris(2-(2-methoxyethoxy)ethyl)ammonium and 1-(2-methoxyethyl)-1-methyl pyrrolidinium, 1-methyl-pyrrolidinium, 1-(4,4,5,5,6,6,7,7,8,8,9,9,10,10,11,11,11-heptadecafluoroundecyl-1-methylpyrrolidinium, trihexyl (4,4,5,5,6,6,7,7,8,8,9,9,10,10,11,11,11-heptadecaluoroundecyl) ammonium cations, and
(b) an anion selected from the group comprising: tris(pentafluoroethyl) trifluorophosphate, tris(perfluoroethyl)trifluoro phosphate, bis(trifluorosulfonyl)imide, nonafluorobutane sulfanoate, nonafluorobutane sulphonate, tridecafluorohexane sulfonate, heptadecafluorooctane sulfonate, 1,1,2,2,-tetrafluoroethane sulfonate, trifluoromethane sulphonate, nonafluoropentanoate, pentadecafluoro octanoate, and tetrakis((1,1,1,3,3,3-hexafluoropropan-2-yl)oxy)borate, tetrakis((1,1,1,3,3,3,-hexafluoropropan-2-yl)oxy) borate, and heptadecafluorononanoate anions.

In a preferred embodiment, the electrolyte further comprises one or more solvents, preferably one or more organic solvents having low viscosity and high conductivity as herein defined.

### Preferred Cations

Preferably the cations are selected from the group comprising: 1-(3,3,4,4,5,5,6,6,7,7,8,8,8-tridecafluorooctyl)-2,3-dimethylimidazolium, 1-(3,3,4,4,5,5,6,6,7,7,8,8,8-tridecafluorooctyl)-3-methylimidazolium, 1-ethyl-3-methylimidazolium, 1-butyl-methyl pyrrolidinium, trihexyl tetradecylphosphonium, tributyl-(4,4,5,5,6,6,7,7,8,8,9,9, 10,10,11,11,11-heptadecafluoro undecyl)-phosphonium, tributyl-(3,3,4,4,5,5,6,6,7,7,8,8,8-tridecafluoroctyl) phosphonium, N-ethyl-N,N,N-tris(2-(2-methoxyethoxy)ethyl)ammonium and 1-(2-methoxyethyl)-1-methyl pyrrolidinium, 1-methyl-pyrrolidinium, 1-(4,4,5,5,6,6,7,7,8,8,9,9,10,10,11,11,11-heptadecafluoroundecyl-1-methylpyrrolidinium, and trihexyl (4,4,5,5,6,6,7,7,8,8,9,9,10,10,11,11,11-heptadecaluoroundecyl) ammonium.

### Preferred Anions

Preferably the anion is selected from the group comprising: tris(pentafluoroethyl) trifluorophosphate, tris(perfluoroethyl)trifluoro phosphate, bis(trifluorosulfonyl)imide, nonafluorobutane sulfanoate, nonafluorobutane sulphonate, tridecafluorohexane sulfonate, heptadecafluorooctane sulfonate, 1,1,2,2,-tetrafluoroethane sulfonate, trifluoromethane sulphonate, nonafluoropentanoate, pentadecafluoro octanoate, and tetrakis((1,1,1,3,3,3-hexafluoropropan-2-yl)oxy)borate, tetrakis((1,1,1,3,3,3,-hexafluoropropan-2-yl)oxy) borate, and heptadecafluorononanoate.

In a particularly preferred embodiment the liquid salt is selected from one or more of the group comprising:
[C₈H₄F₁₃dmim][eFAP];
[C₈H₄F₁₃dmim][NTf₂];
[C_{2,0,1}mpyr][eFAP];
[N_{2(2,O,2,O,1)3}][B(hfip)₄];
[N_{2(2,O,2,O,1)3}][eFAP];
[P_{6,6,6,14}][C₄F₉SO₃];
[P_{6,6,6,14}][C₅F₉CO₂];
[P_{6,6,6,14}][C₆F₁₃SO₃];
[P_{4,4,4,Rf}][C₄F₉SO₃] where Rf═C₁₁H₆F₁₇;
[P_{4,4,4,Rf}][eFAP], where Rf═C₁₁H₆F₁₇; and
a mixture of [P_{6,6,6,14}][eFAP] with [P_{6,6,6,14}][C₈F₁₇SO₃].

In a particularly preferred embodiment of the cell for electrochemical reduction of dinitrogen to ammonia, the reduction of dinitrogen to ammonia occurs principally in a region adjacent a three phase boundary on the working surface of the cathodic working electrode. Typically, the nanostructured electrocatalyst is applied to the working surface of the cathodic working electrode to create the gas/electrolyte/metal three-phase boundary region where electrolysis principally takes place.

Typically, a continuous current will pass between the cathodic working electrode and the counter electrode, however in some applications such as a wind power photovoltaic panel power driven process an intermittent or pulsed current may be suitable.

The cell for electrochemical reduction of dinitrogen to ammonia may include other features well known to those in the art for carrying out electrolytic reactions and controlling the current between the electrodes. For example, the cell may be adapted to control the temperature or pressure of operation using well known means such as heaters, cooling units or pressurising means. In addition, the cell may include an ultrasonic generator for generating sound waves of energy greater than 20 kHz.

The cell for electrochemical reduction of dinitrogen to ammonia preferably includes gas flow layers having the function of allowing introduction to the cell of a stream of gas comprising nitrogen and hydrogen or water vapour, and exit of gas containing ammonia. The ammonia may optionally be collected external to the cell.

In a further embodiment an assembly may be formed when two or more cells according to the present invention are stacked in series. One or more of the stacked cells may additionally be folded or rolled. Gas can be introduced at any convenient location including from the “end” of the longest dimension of the assembly or from either side of the assembly.

### Electrolyte

Using the method and cell of the present invention, it is possible to achieve high-efficiency electrochemical reduction of nitrogen into ammonia at ambient conditions. Without wishing to be bound by theory it is believed that by careful choice of certain organic solvents, the viscosity of liquid salts can be suitably decreased while the mass transportation in the liquid salt can be increased.

The electrolyte typically comprises (a) one or more liquid salts, preferably in combination with (b) one or more organic solvents having low viscosity and high ionic conductivity. The electrolyte may also comprise a controlled amount of water.

The electrolyte is typically a liquid or gelled liquid at the temperature at which the dinitrogen reduction is performed.

### Solvent

When the electrolyte according to the present invention includes a solvent, it will be readily apparent to the person skilled in the art that certain species will be unsuitable. For example, a highly fluorinated hydrocarbon such as a straight perfluoroalkane (e.g. perfluorooctane) would not readily dissolve the liquid salts of the present invention. It will also be apparent to the skilled person that small fluorinated species such as perfluoroalkyl chains would also be unsuitable because they only exist as gases at ambient temperature. Furthermore, reactive solvents, such as acids, alcohols and those having other halogen substituents would be clearly unsuitable.

The preferred solvents for use in the present invention have low viscosity and provide high ionic conductivity. Preferably, the boiling point of the solvent should not be so low that volatility is an issue when bubbling dinitrogen through the electrolyte.

In general, the solvent has an appropriate balance of organic moieties and polarity. Hence fluoroalkyl chains, fluorinated esters, ketones, ethers, sulfoxides and phenyls are potentially suitable or can be adapted. For example, the proportion of fluorine anions in the solvent could be reduced, by introducing more functional moieties (e.g. oxygen) to the solvent structure. Suitable solvents would include the following (and their variants): 1,1,1,6,6,6-hexafluorohexane, methyltrifluoroacetate, ethyltrifluoroacetate, octafluorotoluene, trifluorotoluene, (2,2,2-trifluoroethoxy)pentafluorobenzene, 1,2,4,5-tetrafluorobenzene, 1,3,5-tris(trifluoromethyl)benzene, 1,3-bis(1,1,2,2-tetrafluoroethoxy)benzene, 1,3-bis(trifluoromethyl)benzene, 1-fluoro-4-(trifluoromethoxy)benzene, 2-fluorobenzotrifluoride and pentafluorobenzene.

The solvents may be at least partially fluorinated, preferably fully fluorinated. In a preferred embodiment the solvent is 1H,1H,5H-octafluoropentyl 1,1,2,2-tetrafluoroethyl ether (FPEE) or 1,1,2,2,3,3,4-heptafluorocyclopentane (HFCP) or trifluorotoluene (TFT).

Preferably, the solvent is present in the liquid salt at a level between 0.1 mol % and 90.0 mol %, more preferably between 0.2 mol % and 20.0 mol % and most preferably between 0.5 mol % and 50.0 mol %.

In a preferred embodiment both the solvent and the liquid salt are fluorinated.

### Source of Hydrogen

In one embodiment, the external source of hydrogen is a controlled amount of water that is continuously introduced into the electrolyte or gas stream. In another embodiment the hydrogen source may also be H₂ gas that is introduced as an anode reactant, producing protons in the electrolyte. In a further embodiment, the source of hydrogen is an acid such as sulphuric acid where the product is intended to be separated as an ammonium slat such as ammonium sulphate.

The thermodynamic activity of hydrogen (as protons) in the electrolyte can be controlled, for example, by additions of amounts of acid or alkaline components to the electrolyte formulation. One preferred method of doing so is to add the acid of the liquid salt anion or the hydroxide salt of the liquid salt cation to respectively raise of lower the electrolyte proton activity.

### Liquid Salt

Where used herein the term liquid salt is intended to refer to an ion conductive medium that is liquid or that can be rendered liquid by mixing with one or more solvents at the temperature of use and that contains one or more salts (each of which may be solid or liquid in their pure states). The salts may be selected from any suitable metal salts, organic salts, protic salts, complex ion salts or the like.

The liquid salt can also be formed by mixing several salts to create the desired characteristics.

The electrolyte comprising the one or more liquid salts provides an ion conductive medium in which the process reactions occur. The electrolyte of the present invention offers the advantage that some gases are more soluble in these electrolytes comprising the one or more liquid salts than in water. In particular, some electrolytes comprising the one or more liquid salts can provide an elevated solubility for N₂ gas (compared to aqueous and other electrolytes) thereby increasing the concentration of N₂ at the electrolyte/electrode interface.

In a preferred embodiment the cation and/or anion of the liquid salt is fluorinated or perfluorinated. The preferred solvent preferably (i) dissolves the liquid salt at levels between 0.1 mol % and 90.0 mol % and (ii) is sufficiently electrochemically stable in the potential range where the nitrogen reduction reaction takes place.

It is also particularly preferred that the liquid salt and/or the solvent has a relatively high nitrogen solubility (compared, for example, to liquid salts of the prior art such as imidazolium salts and nitrile based anions such as dicyanamide). Preferably the nitrogen solubility greater than about 100 mg/L.

The electrolyte is typically in the form of a layer. Preferably the electrolyte includes a spacer or electrolyte membrane (which itself may act as an electrolyte), for example a polymer electrolyte such as Nafion™ or a Nafion™-liquid salt blend, or a gelled liquid salt electrolyte, or is an electrolyte soaked into a porous separator such as paper or Celeguard™.

In a further embodiment of the present invention, there is provided an electrolyte membrane comprising a thin layer of material combined with one or more liquid salts as herein described for use in the cell of the present invention.

In a further embodiment of the present invention, the electrolyte flows through a porous electrode or over the surface of a non-porous electrode such that the N₂ is carried continuously to the electrode and the ammonia produced is continuously removed from the cell, to be separated from the electrolyte in a subsequent process.

### Catalyst

Preferably, the catalyst for electrochemical reduction according to the present invention comprises nanostructured materials having a high electrochemical working surface area, as indicated by a double layer capacity, measured in an adjacent electrolyte layer of greater than 0.1 mF/cm² and preferably greater 1 mF/cm².

Preferably, the nanostructured catalyst comprises one or more metals in the form of elemental metal or inorganic compounds comprising one or more metals. The nanostructured catalyst may be in the form of discrete particles or sheet or film or three dimensional structure. The nanostructured catalyst embodies morphological features that may be of any shape with at least one dimension in the range of 1 nm to 1000 nm.

Suitable metals include any of the transition metals or lanthanide metals including Fe, Ru, Mo, Cu, Pd, Ti, Ce and La as well as their alloys with other metals and semimetals.

The aforementioned metals may be surface decorated with an oxide or a sulfide of the metal, or a composite may be formed of the metal with its oxides or sulfides.

The catalyst may also comprise a metal complex consisting of two metals bridged by sulfides. Preferably, the metals are Fe and Mo.

For example, the catalyst may be a nanoparticle film prepared as a composite material with binder to form a film. As such, the nanoparticle film may be prepared by a cyclic voltammetry or a pulsed voltammetry electrodeposition method.

In another preferred embodiment the catalyst may comprise conductive polymer materials such as poly(3,4-ethylenedioxythiophene) (PEDOT).

In yet another preferred embodiment the catalyst may comprise doped carbon materials, particularly carbons doped with N and/or S or metal atoms or particles.

The catalyst is preferably supported or decorated on an electrically conductive, chemically inert support. Suitable supports include fluorine-doped tin oxide, graphene, reduced graphene oxide, porous carbons, carbon cloth, carbon nanotubes, conducting polymers and porous metals.

Faradaic efficiency is a particular deficiency of related processes of the prior art. Faradaic efficiency can be used to describe the fraction of electric current that is utilised in the N₂ reduction reaction. The remaining fraction that is, (100−Faradaic efficiency) %, is consumed in undesirable side reactions including the production of H₂ and hydrazine. These bi-products represent wasted energy and may also require complex separation methods from the desired product. It is one of the purposes of the present invention to provide a method of relatively high Faradaic efficiency preparation of ammonia.

Other aspects and preferred forms are disclosed in the specification and/or defined in the appended claims, forming a part of the description of the invention.

In essence, embodiments of the present invention stem from the realization that the efficiency of ammonia production can be improved by use of a hybrid electrolyte, that is, a combination of specific liquid salts and organic solvents that increase mass transport during the electrochemical reduction reaction.

Advantages provided by the present invention compared with the processes of the prior art comprise the following:
conversion of dinitrogen to ammonia with high Faradaic efficiency and high yield rate;
the reaction can be carried out at ambient temperature and pressure;
greater solubility of dinitrogen in the electrolyte;
increased activity and improved dinitrogen reaction performance in the reduction reaction;
lower rate of undesirable competing reaction such as H₂ production; and
high mass transport and conductivity in the electrolyte.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates X-ray diffraction (XRD) characterization of the synthesized CFP supported Fe NRR cathodes (1 Fe₂O₃; 2 α-Fe; 3 β-FeOOH);

FIG. 2 illustrates scanning electron microscopy (SEM) photographs of (FIG. 2a-FIG. 2b) β-FeOOH and (FIG. 2c FIG. 2d) α-Fe;

FIG. 3 is a schematic illustration of the NRR electrochemical cell used to generate the experimental results disclosed herein (showing 4—counter electrode; 5—reference electrode, 6—working electrode; 7—counter electrode separating tube);

FIG. 4 depicts the chemical structure of the liquid salt [C₄mpyr][eFAP] and solvent FPEE;

FIG. 5 is a plot illustrating the conductance dependence on [C₄mpyr][eFAP] mol fraction (XIL) in FPEE at 25° C. (9), 35° C. (10) and 40° C. (11);

FIG. 6 is a plot illustrating cyclic voltammetries (CVs) demonstrating the electrochemical potential window of [C₄mpyr][eFAP] and FPEE/[C₄mpyr][eFAP] mixtures with different concentrations (X_{IL}=0.06 (16), 0.23 (17), 0.70 (18) and 1.00 (19));

FIG. 7 is a plot of potential dependence of NH₃ yield and Faradaic efficiency (%) in 25 wt. % mixture of [C₄mpyr][eFAP] in FPEE;

FIG. 8 is a plot of constant potential electrolysis (CPE) at −0.65 V vs. normal hydrogen electrode (NHE) in mixed electrolytes with different X_{IL}, (X_{IL}/IL wt % 0.46/60% (30), 0.12/20% (31); 0.20/30% (32); 0.27/40% (33); 0.23/35% (34));

FIG. 9 XIL ([C₄mpyr][eFAP] in FPEE) is a plot of dependence of NH₃ yield and Faradaic efficiency (%) at an applied potential of −0.65 V vs. NHE;

FIG. 10 illustrates a preferred configuration of a liquid flow cell for N₂ reduction to ammonia, the cell consisting of two electrodes, a porous, high surface area cathode (40) and an H₂ gas oxidation anode (42) which are separated by a proton conducting polymer membrane (44). Adjacent the anode (42) is the H₂ gas diffusion layer (46) which is supplied with H₂ gas from an external source (48) entering via a first inlet (50), the unreacted H₂ gas leaving via a first outlet (52). The porous cathode (40) is supplied with N₂ saturated electrolyte from an N₂ bubbler (54) via a second inlet (56) and electrolyte, NH₃, H₂ and unreacted N₂ leave via a second outlet (58). NH₃ and H₂ are removed from the electrolyte in a product separation vessel (60) and the electrolyte and unreacted N₂ enters the N₂ bubbler (54);

FIG. 11 illustrates a preferred configuration of a liquid flow cell for N₂ reduction to ammonia, the cell consisting of two electrodes, a porous, high surface area cathode (62) and an H₂ gas oxidation anode (64) which are separated by a proton conducting polymer membrane (66). Adjacent the anode (64) is the H₂ gas diffusion layer (68) which is supplied with H₂ gas from an external source (70) entering via a first inlet (72), the unreacted H₂ gas leaving via a first outlet (74). The porous cathode (62) is supplied with N₂ saturated electrolyte from an N₂ bubbler (76) via a second inlet (78) and electrolyte, NH₃, H₂ and unreacted N₂ leave via a second outlet (80). NH₃ and H₂ are removed from the electrolyte in a product separation vessel (82) and the electrolyte and unreacted N₂ enters the N₂ bubbler (76). H₂ leaves the separation vessel (82) and enters the first inlet (72);

FIG. 12 is a schematic diagram showing a typical electrochemical cell for N₂ reduction according to the present invention, the cell comprising a power source (91), cathode (92), membrane (93) and anode (94). The counter electrode reaction in the process may be water or hydroxide oxidation, as illustrated. Alternatively, where the desired product is the fertiliser ammonium sulfate, the counter electrode reaction may be SO₃⁻² to SO₄⁻²;

FIG. 13a and FIG. 13b comprise a pair of plots illustrating the dependence of viscosity and conductivity on the TFT mole fractions (xTFT) in [C₄mpyr][eFAP] (▪ 298K; ● 308K; [symbol] 318K; and [symbol] 328K);

FIG. 14 is a plot of CV of Fe electrodes in different electrolytes containing [C₄mpyr][eFAP] and TFT at different mole fractions; and

FIG. 15 is a plot illustrating Faradic efficiency and the yield rate for ammonia synthesis in NRR (▪ FE %; □ yield rate). All experiments were conducted on SS supported Fe electrodes by applying a constant potential of −0.8 V vs RHE for 30 min to 1 hr.

FIG. 16 is a plot of viscosity at various temperatures (▪ 298K; ● 308K; [symbol] 318K; [symbol] 328K and [symbol] 338K) for a range of mixtures of HFCP/[C₄mpyr][eFAP];

FIG. 17 is a plot of viscosity at various temperatures (▪ 298K; ● 308K; [symbol] 318K; [symbol] 1328K and [symbol] 338K) for a range of mixtures of FPEE/[C₄mpyr][eFAP];

FIG. 18 is a plot of conductivity at various temperatures (▪ 298K; ●308K; [symbol] 318K; [symbol] 328K and [symbol] 338K) for a range of mixtures of HFCP/[C₄mpyr][eFAP];

FIG. 19 is a plot of conductivity at various temperatures (▪ 298K; ● 308K; [symbol] 318K; [symbol] 328K and [symbol] 338K) for a range of mixtures of FPEE/[C₄mpyr][eFAP];

FIG. 20 is a plot of N₂ solubility against mole fraction ratios of 0, 0.75, 0.87, 1 TFT/[C₄mpyr][eFAP] mixtures at 30° C.;

FIG. 21 is a plot of N₂ solubility against mass fraction ratios of 0, 0.75, 0.87, 1 TFT/[C₄mpyr][eFAP] mixtures at 30° C.

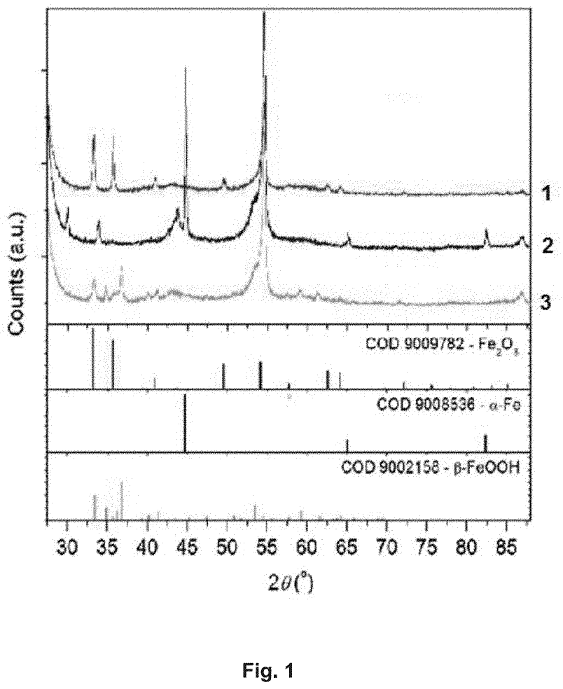

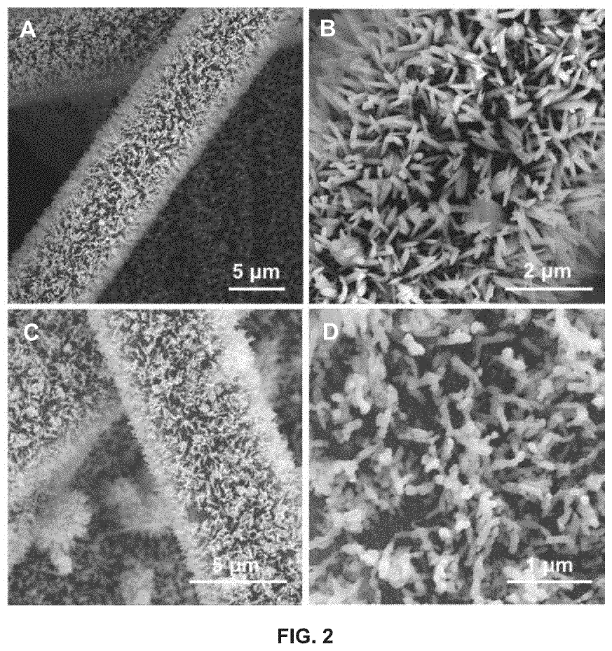

### ABBREVIATIONS

Where used herein the abbreviations refer to the following chemical species:
B(hfip)₄—tetrakis((1,1,1,3,3,3-hexafluoropropan-2-yl)oxy)borate
B(otfe)₄—tetrakis(2,2,2-trifluoroethoxy)borate
CF₃SO₃—nonafluorobutante sulfonate
C₂H₂F₄SO₃—1,1,2,2-tetrafluoroethane sulfonate
C₂mim—1-ethyl-3-methylimidazolium
C_{2,0,1}mpyr—1-(2-methoxyethyl)-1-methyl pyrrolidinium
C₄mpyr—1-butyl-methyl pyrrolidinium
C₄F₉SO₃—nonafluorobutanesulphanoate
C₅F₉CO₂—nonafluoropentanoate
C₆F₁₃SO₃—tridecafluorohexane sulfonate
C₈H₄F₁₃mim—1-(3,3,4,4,5,5,6,6,7,7,8,8,8-tridecafluorooctyl)-3-methylimidazolium
C₈H₄F₁₃dmim—1-(3,3,4,4,5,5,6,6,7,7,8,8,8-tridecafluorooctyl)-2,3-dimethylimidazolium
C₈F₁₅O₂—pentadecafluoro octanoate
C₈F₁₇SO₃—heptadecafluoroctane sulfonate also known as PFO
C₉F₁₇O₂—heptadecafluoro nonanoate
C₁₁H₆F₁₇mpyr—1-(4,4,5,5,6,6,7,7,8,8,9,9,10,10,11,11,-heptadecafluoro undecyl-1-methylpyrrolidinium
DMSO—dimethyl sulfoxide
eFAP—tris(perfluoroethyl) trifluorophosphate
FPEE—1H, 1H,5H-octafluoropentyl 1,1,2,2-tetrafluoroethyl ether
HFCP—1,1,2,2,3,3,4-heptafluorocyclopentane
Hmpyr—1-methyl-pyrrolidinium
MPN—3-methoxypropionitrile
N_{2(2,O,2,O,1)3}—N-ethyl-N,N,N-tris(2-(2-methoxyethoxy)ethyl)ammonium
N_{4,4,4}Rf—trihexyl(4,4,5,5,6,6,7,7,8,8,9,9,10,10,11,11,11-heptadecafluoroundecyl) ammonium (Rf is C₁₁H₆F₁₇)
NTf₂—bis(trifluoromethyl sulfonyl)imide
OFT—octafluorotoluene
P_{4,4,4},Rf—tributyl-(4,4,5,5,6,6,7,7,8,8,9,9,10,10,11,11,11-heptadecafluoro undecyl)-phosphonium (where Rf═C₁₁H₆F₁₇ or C₈H₄F₁₃ as specified)
P_{6,6,6,14}—trihexyl tetradecyl phosphonium
PBSF—perfluoro-1-butanesulfonyl fluoride
PC—propylene carbonate
PEDOT—poly(3,4-ethylenedioxythiophene
POSF—perfluoro-1-octanesulfonyl fluoride
PFMD—perfluoromethyldecalin
PFHex—perfluorohexane
PFOct—perfluorooctane
TFE—trifluoroethanol
TFT—trifluorotoluene

### DETAILED DESCRIPTION

The present invention will be further described with reference to the following non-limiting examples. These examples explore a range of organic solvents for the development of a new electrolyte, based on a combination of certain liquid salts and organic solvents, having low viscosity, high conductivity and high N₂ solubility.

The method of the present invention utilising an electrolyte based on the combination of certain liquid salts and solvents cannot only significantly increase the solubility of dinitrogen but also increase mass transport during the reduction reaction and at the same time lower the rate of undesirable competing reactions such as H₂ production.

### Solvents—Table 1

A series of organic solvents as listed in Table 1 were examined as electrolyte solvents. The ionic conductivity was measured by electrochemical impedance spectroscopy (EIS) using a dip-cell connected to temperature controller. Among the organic solvents, triflourotoluene shows a good compatibility with NRR system which was systematically studied with different mole fraction additions (X_{TFT}=0˜0.96) for the electrochemical dinitrogen reduction reaction.

All chemicals were used without any further purification unless otherwise stated. 1-butyl-1-methylpyrrolidinium tris(pentafluoroethyl) trifluorophosphate ([C₄mpyr][eFAP]) was purchased from Merck. The liquid salt was pre-treated by known procedures. The [C₄mpyr][eFAP] was preconditioned to be slightly alkaline by washing with 1 mM KOH three times, then it was dried in vacuum for 8 hrs followed by further drying with molecular sieves. The dried liquid salt was then transferred to a vial through which dinitrogen was bubbled (10 mL min⁻¹) for at least 12 h to fully equilibrate the liquid with respect to dinitrogen and water before use in experiments.

### Electrode Preparation

An iron (Fe) catalyst electrode was prepared by an electrodeposition method. In a typical experiment, the electrolyte for the deposition containing 10 mM iron sulfate (FeSO₄), 10 mM citric acid and 20 mM sodium hydroxide (NaOH). Stainless steel (SS) cloth was used as the substrate. The deposition was conducted in a three-electrode system by using a SS cloth, a saturated calomel electrode (SCE) and a titanium mesh as the working, reference and counter electrodes, respectively. The Fe nanostructured catalyst was electrodeposited by cycling the potential for 10 times between −1.8 V and −0.8 V at a sweep rate of 0.02 V s-1. After deposition, the sample was rinsed with distilled water thoroughly and dried with nitrogen.

### Electrochemical Measurement and Conversion of N₂ to Ammonia

Electrochemical reduction of dinitrogen was conducted in a three-electrode configuration with dinitrogen gas flowing over the working electrode. Cyclic voltammograms were measured in a single compartment cell, while ammonia production at fixed potential was conducted by isolating the platinum counter electrode with a glass frit in a typical H-cell arrangement. The ionic conductivity was measured by EIS using a dip-cell connected to temperature controller. All electrochemical deposition and electrochemical experiments were carried out at ambient condition.

For the examined aprotic solvents, octafluorotoluene (OFT) exhibited only partial miscibility (up to 0.8 mole fraction), while trifluorotoluene (TFT) showed good miscibility at any mole fraction. The compatibility of these miscible solvents was tested using the ammonia detection method.

Most of the protic solvents, except 3-methoxypropionitrile (MPN), interfere with the ammonia detection method. Those skilled in the art would understand that these solvents can be examined further if alternative ammonia detection methods are adopted to avoid the interference. The aprotic solvents, TFT and OFT both exhibited good compatibility with the ammonia detection method.

Another important criterion is that the solvent meets the requirement of electrochemical stability in the potential range where dinitrogen reduction is conducted. Although MPN has been used in many electrochemical reactions as a stable solvent, it decomposed when a large amount of ammonia was detected in blank argon gas experiments. However, the TFT exhibited good electrochemical stability. Thus, based on the overall performance of the examined solvents, TFT was selected for further study.

TABLE 1A
Comparison of the miscibility with liquid salt ([C₄mpyr][eFAP], interference
with the ammonia detection method (indophenol) and electrochemical stability.

| | | Interference | Increased | |
|---|---|---|---|---|
| | Miscibility | with NH₃ | current density | |
| | with liquid | detection | compared to | Electrochemical |
| | salt | method | pure liquid salt | stability |
| Propylene carbonate | Y | Y | Y | — |
| (PC) | | | | |
| 3-Methoxypropionitrile | Y | N | Y | Decomposed |
| (MPN) | | | | |
| Dimethyl sulfoxide | Y | Y | Y | Y |
| (DMSO) | | | | |
| Diglyme | Y | Y | Y | Y |
| Trifluoroethanol | Y | Y | Y | — |
| (TFE) | | | | |
| Toluene | N | — | N | — |
| Trifluorotoluene | Y | N | Y | Y |
| (TFT) | | | | |
| Octafluorotoluene | Up to 0.8 mol | N | Y | — |
| (OFT) | fraction | | | |
| Perfluorooctane | N | — | N | — |
| Diethyl ether | N | — | N | — |
| Chloroform | N | — | N | — |
| Tetrahydrofuran | Y | — | Y | Y |
| Ethyltrifluoroacetate | Y | — | — | Y |
| 1H,1H,5H- | Y | N | Y | Y |
| octafluoropentyl | | | | |
| 1,1,2,2-tetrafluoroethyl | | | | |
| ether | | | | |
| (FPEE) | | | | |
| 1,1,2,2,3,3,4- | Y | N | Y | Y |
| heptafluorocyclopentane | | | | |
| (HFCP) | | | | |

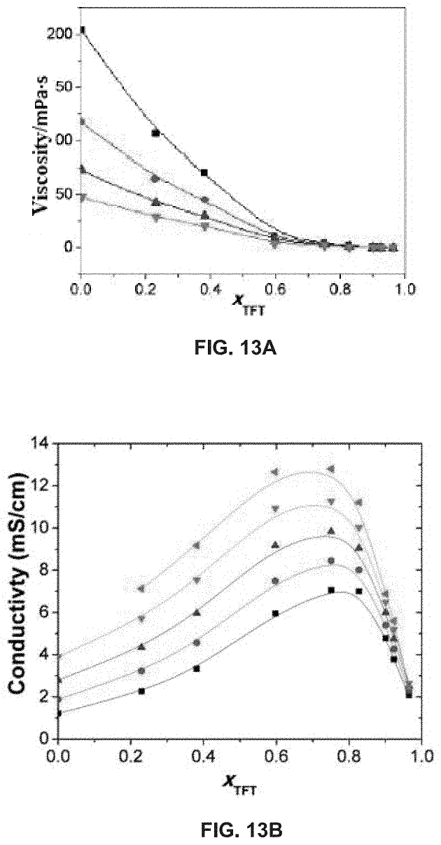

Viscosity and conductivity are important factors for electrochemical reactions, as they affect mass transport and electron transfer performance. A range of mixtures of liquid salt ([C₄mpyr][eFAP]) and TFT were prepared with different TFT solvent mole fractions (xTFT=nTFT/(nTFT+nLS)). The density and viscosity of the mixtures were measured as shown in FIG. 13a. The viscosity decreased significantly with the addition of TFT. Specifically, the viscosity at 298 k dropped from 204 mPa·s in pure liquid salt to 107 mPa·s at xTFT=0.23, and dropped further to 11 mPa·s at xTFT=0.6. A further increase in the TFT concentration caused the viscosity to decrease, however not significantly. As shown in FIG. 13a, the viscosity decreased significantly as the temperature increased for the mixture with low TFT concentration, whereas the viscosity decreased only slightly at high TFT concentrations.

The addition of TFT into the liquid salt also substantially changed the conductivity as shown in FIG. 13b. The pure liquid salt showed low conductivity, i.e., 1.2 mS cm⁻¹ at 298K. It increased with the addition of TFT, as high as 6.3 mS cm-1 at xTFT=0.75, where the conductivity started to drop with addition of more TFT. The initial increase in conductivity is believed to be mainly due to the drop in viscosity as shown in FIG. 13a to promote the ion transportation. However, when more TFT is added, there are not enough ions present in the electrolyte to support fast charge transfers, and as a result, the conductivity decreases as shown in FIG. 13b at higher mole fraction. (MacFarlane, D. R. et al, 2017, Faraday Discuss., 206, 9-28).

The general method used for determining N2 solubility is as follows: N2 solubility is measured using dual-volume apparatus based on the isochoric saturation method. In this method, a ballast chamber is used to deliver a known amount of gas to the equilibrium chamber containing the degassed liquid sample. When pressure equilibrium is established between the liquid sample and its headspace, the solubility of N2 in the liquid sample can then be determined.

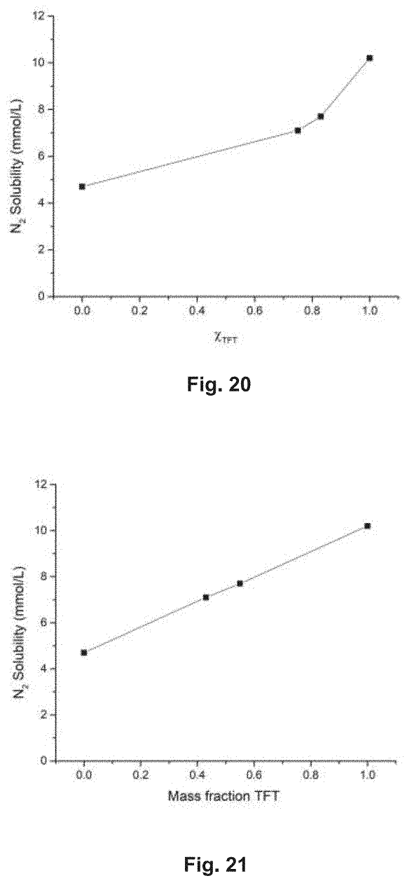

FIG. 20 and FIG. 21 are plots of N2 solubility against mole/mass fraction ratio of TFT/[C4mpyr][eFAP] at 30° C. N2 solubility values are shown in table 1B, including the N2 solubility of fluorous solvents FPEE and HFCP.

Solution 1 (FIG. 20) comprised 0.87 TFT/[C₄mpyr][eFAP] mole fraction mixture: 7.7 mmol/L. Solution 2 (FIG. 20) comprised 0.75 TFT/[C₄mpyr][eFAP] mole fraction mixture: 7.0 mmol/L.

From the obtained data, plotting mole fraction versus the nitrogen solubility does not show a consistent, steady trend. However, plotting mass fraction versus the nitrogen solubility shows a very clear linear trend. This observation could suggest that in this system, nitrogen solubility is dominated by physical absorption rather than chemical absorption.

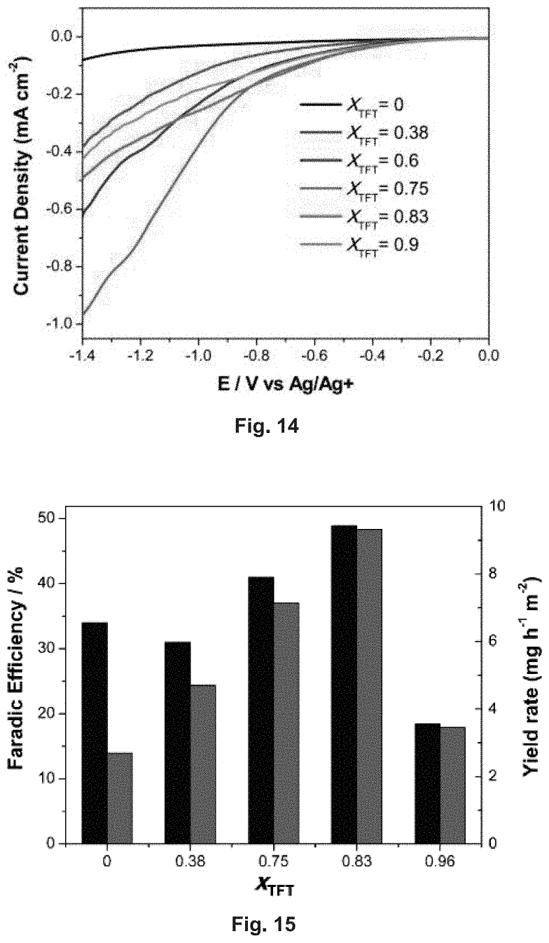

Cyclic voltammetric (CV) measurements were carried out on the stainless steel cloth supported Fe electrodes in the hybrid electrolytes with different composition. The results are shown in FIG. 14. It can be seen that with the addition of TFT, the current density increased significantly, and the more TFT added, the higher the current density until the TFT mole fraction reached 0.75. After that, the current density dropped with the increase of the TFT concentration. This is due to the further increase of the TFT concentration despite continued reduction of the viscosity, which promotes the mass transport, however, the significant decrease of conductivity becomes a limitation to further current increase.

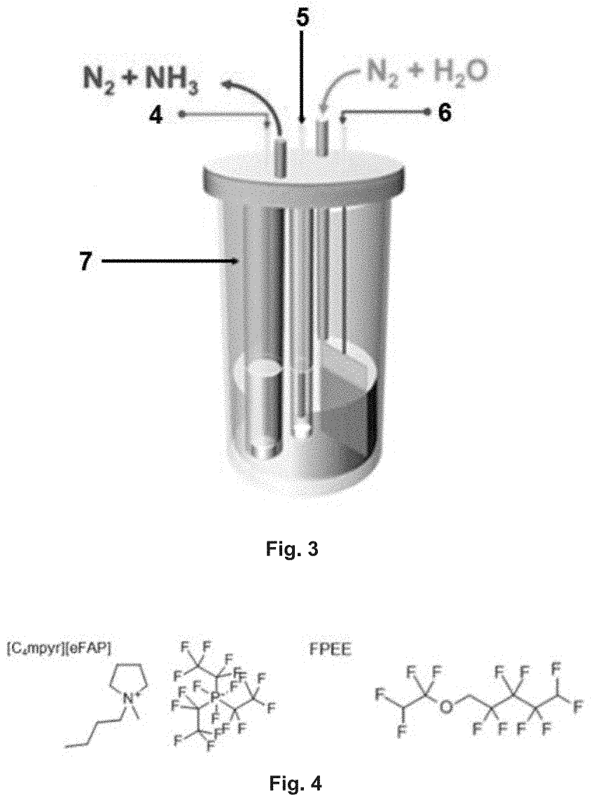

Dinitrogen electrochemical reductions were conducted on the stainless steel supported Fe electrode in the above electrolytes and FIG. 15 shows the Faradic efficiency (FE) and the yield rate conducted at −0.8 V vs RHE, which is slightly less negative than the onset potential for all the electrolytes as shown in FIG. 3.

The Faradic efficiency for ammonia synthesis increased with the addition of TFT until up to xTFT=0.83, but further increases in the TFT concentration reduced the efficiency. This means that reasonable TFT addition can improve the selectivity for dinitrogen reduction. It is worth noting that the yield of ammonia increased significantly in the presence of TFT. For example, the yield rate at xTFT=0.83 is 48 mg h⁻¹m⁻², which is more than three time of the number in pure liquid salt (14 mg h⁻¹ m⁻²). This indicates that the addition of TFT can significantly improve the ammonia electrochemical synthesis.

In an electrochemical dinitrogen reduction reaction, two main performances are important for practical application: (i) the ammonia selectivity or Faradic efficiency and (ii) the yield rate. The Faradic efficiency reflects the energy conversion efficiency from electricity to chemicals, while the yield rate is more important for industry as it directly relates to the production capability. Previous inventions, such as those described in International Patent Application PCT/AU2017/000036 have successfully increased the Faradic efficiency by introducing fluorine-based liquid salt electrolytes. The present invention significantly improves the ammonia yield rate of those electrolytes by introducing solvents into the liquid salt electrolyte.

As illustrated in FIG. 13, the viscosity of the electrolyte significantly decreases with TFT addition, and the conductivity is also increased in the presence of a reasonable amount of TFT. Both of them will improve the mass transport during electrochemical reaction, which was a limiting factor for improvement of dinitrogen reduction reaction in highly viscous liquid salts. With the TFT present, the decreasing of viscosity promotes the transfer of protons and dissolved nitrogen to the electrode surface to participate the electro reactions.

In addition, it should be noted that the Faradic efficiency for ammonia synthesis increased rather than decreased. This may be due to TFT also having high dinitrogen solubility, given that TFT is a fluorous organic liquid that has strong interaction with dinitrogen to promote the dinitrogen solubility. Other fluorous solvents such as octafluorotoluene (listed in Table 1A) are also promising solvents for dinitrogen reduction. Table 1B further illustrates the N₂ solubilities of various fluorous solvents.

TABLE 1B
N₂ solubilities of various fluorous solvents

| | |
|---|---|
| Component(s) | N₂ solubility |

| Pure liquids | | | |
|---|---|---|---|
| [C₄mpyr][eFAP] | | 4.70 | mmol/L |
| TFT | | 10.2 | mmol/L |
| FPEE | | 13.7 | mmol/L |
| HFCP | | 12.4 | mmol/L |
| Mixtures of | Mixtures of | | |
| TFT/[C₄mpyr][eFAP] | TFT/[C₄mpyr][eFAP] | | |
| (mol fraction) | (mass fraction) | | |
| 0.83 | 0.55 | 7.7 | mmol/L |
| 0.75 | 0.43 | 7.0 | mmol/L |

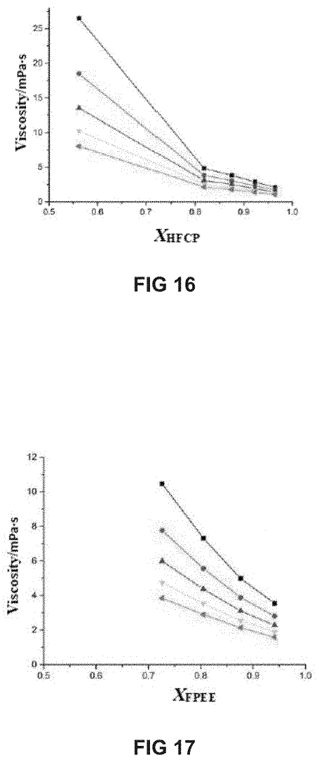

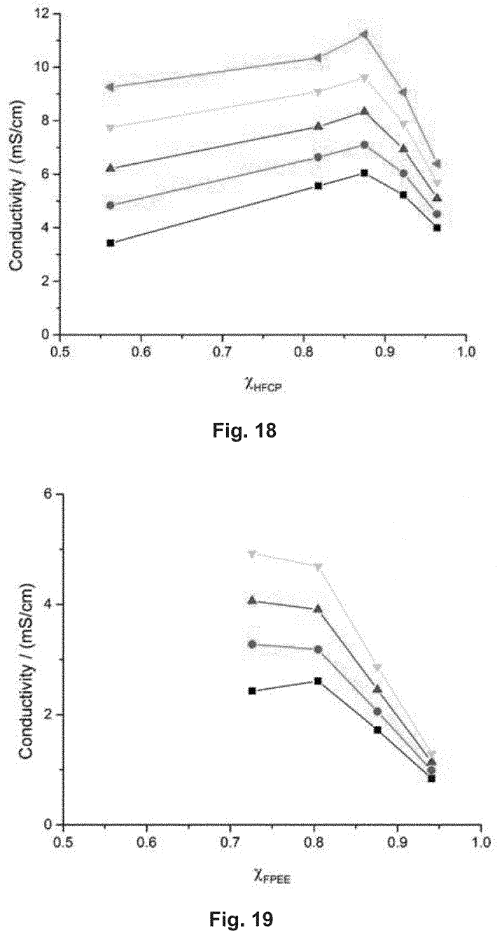

FIGS. 16 to 19 illustrate the results of measuring viscosity and conductivity for a range of mixtures consisting of HFCP/[C₄mpyr][eFAP], and FPEE/[C₄mpyr][eFAP]. The viscosity decreases as the mole fraction of solvent increases across all temperatures.

As the temperature increases, the viscosity of the solvent/liquid salt mixture decreases. Solvent/liquid salt mixtures that exhibit higher viscosities are affected by temperature more than those mixtures with low viscosity. For example, the viscosities of HFCP/[C₄mpyr][eFAP] (χ=0.56) are 26.5 mPa s and 8.0 mPa s at 298K and 338K respectively, showing a decrease of 18.5 mPa s. On the other hand, the viscosities of HFCP/[C₄mpyr][eFAP] (χ=0.96) are 2.1 mPa s and 1.0 mPa s at 298K and 338K respectively, showing a decrease of 1.1 mPa/s.

The addition of fluorous solvent affects the conductivity when added to [C₄mpyr][eFAP]. Increasing the amount of fluorous solvent enhances the conductivity which may be the result of the viscosity decreasing. However through the addition of more solvent, the conductivity decreases as a result of a decline in the number of species in the electrolyte to support fast charge transfers. There is an observed peak at which the mole fraction of solvent/[C₄mpyr][eFAP] reaches an optimum. For the HFCP/[C₄mpyr][eFAP] mixtures, this optimum peak occurs at a mole fraction of 0.87. On the other hand, the peak conductivity for FPEE/[C₄mpyr][eFAP] occurs at a mole fraction of 0.80 at 298K; furthermore this peak shifts upon increasing temperature suggesting a change in interactions and contributions to conductivity.

### Salt Solubility—Table 2

Table 2 lists the compounds described herein as examples and their solubility in a series of exemplary solvents.

With particular reference to Table 2 the general method used for determining the solubility limit of a salt in a solvent is as follows. To make up a salt/solvent electrolyte, an aliquot of salt was added, in steps, to a known mass of solvent. After each aliquot addition, the salt/solvent electrolyte was shaken in a vortex mixer and allowed to settle. Dissolution of a salt in solvent was determined by observing a single phase and the lack of any liquid/solid particles in this phase after the electrolyte is shaken. Further aliquots of salt were added until dissolution no longer occurred. Unless described otherwise, the solubility of a salt in a solvent is represented by Max(X_{α}) reported as mole fraction of the salt (Xα) in the mixture.

Where a salt/solvent mixture is noted as “insoluble” this indicates that the solubility is lower than of interest in electrochemical applications (where Max(Xα))<0.01).

Where a solubility limit was not found but is at least sufficient for electrochemical use, the word “soluble” is noted in Table 2 and the Example. This includes systems where the two components are soluble in all proportions.

It is noted that some salt/solvent electrolytes were not electrochemically tested at their determined solubility limit. In these cases, the mole fraction used is recorded as “X_{α}” in Table 2 below and in the Examples.

Other solvents tested include octafluorotoluene (OFT), perfluoro-1-butanesulfonyl fluoride (PBSF), perfluoro-1-octanesulfonyl fluoride (POSF), perfluorohexane (PFHex), perfluorooctane (PFOct), perfluoromethyldecalin (PFMD) and 1,1,1,5,5,6,6,6-Octafluoro-2,4-hexanedione (OFHD).

### Synthesis, Characterisation, Solubility and Electrochemistry

TABLE 2
Preferred Salt/solvent Electrolyte Combinations and Comparative Examples

| | Solvent | | |
|---|---|---|---|
| | (A) 1H,1H,5H- | (B) 1,1,2,2,3,3,4 | |
| | Octafluoro pentyl | Heptafluoro | |
| | 1,1,2,2-tetrafluoro | cyclopentane | |
| Salt | ethyl ether (FPEE) | (HFCP) | Other solvent |
| [C₈H₄F₁₃dmim][eFAP] | Max(Xα) = 0.17. | Max(Xα) = 0.15. | Nil |
| | Xα = 8.45 × 10⁻²; | Not tested | |
| | Yield rate = 1.34 × | electrochemically. | |
| | 10⁻¹¹ mol/cm²/s; | | |
| | FE 48% | | |
| | Electrode = Fe on FTO | | |
| | Potential = −1.2 V vs | | |
| | Ag/Ag+ | | |
| [C₈H₄F₁₃dmim][NTf₂] | Max solubility = 0.03 | Soluble | Nil |
| | mol/L | Not tested | |
| | Not tested | electrochemically | |
| | electrochemically | | |
| [C_{2,0,1} mpyr][eFAP] | Not tested, | Soluble | Nil |
| | | Xα = 0.35; | |
| | | Yield rate: 1.9 × | |
| | | 10⁻¹¹ moles/cm²/s; | |
| | | FE 12% | |
| | | Electrode = α- | |
| | | Fe@Fe₃O₄ NR on | |
| | | CFP, | |
| | | Potential = 1.85 V vs | |
| | | Ag/Ag+. | |
| [P_{6,6,6,14}][C₄F₉SO₃] | Soluble | Not tested. | Nil |
| | Xα = 0.17; | | |
| | Yield rate = 5.3 × | | |
| | 10⁻¹² mol/cm²/s; | | |
| | FE = 15% | | |
| | Electrode = Fe on FTO | | |
| | Potential = −2.0 V vs | | |
| | Ag/Ag+ | | |
| [P_{6,6,6,14}][C₄F₉CO₂] | Soluble | Soluble | Nil |
| | Xα = 0.18; | Xα = 0.11; | |
| | Yield rate = 2.14 × | Yield rate = 2.2 × | |
| | 10⁻¹² mol/cm²/s; | 10⁻¹² mol/cm²/s | |
| | FE = 2.5% | FE = 1.5% | |
| | Electrode = Fe on FTO | Electrode = Fe on FTO | |
| | Potential = −2.0 V vs | Potential = −2.0 V vs | |
| | Ag/Ag+ | Ag/Ag+ | |
| [P_{6,6,6,14}][C₆F₁₃SO₃] | Not tested. | Soluble | Nil |
| | | Xα = 0.098; | |
| | | Yield rate = 2.5 × | |
| | | 10⁻¹² mol/cm²/s | |
| | | FE = 4.1% | |
| | | Electrode = Fe on FTO | |
| | | Potential = −2.0 V vs | |
| | | Ag/Ag+ | |
| [P_{4,4,4},Rf][C₄F₉SO₃] | Soluble | Not tested | Nil |
| Rf = C₁₁H₆F₁₇ | Xα = 0.15; | | |
| | Yield rate = 2.10 × | | |
| | 10⁻¹² mol/cm²/s; | | |
| | FE = 5.3% | | |
| | Electrode = Fe on FTO | | |
| | Potential = −2.0 V vs | | |
| | Ag/Ag+ | | |
| [P_{4,4,4,Rf}][eFAP] | Not tested | Not tested | Nil |
| Rf = C₁₁H₆F₁₇ | | | |
| [N_{2(2,O,2,O,1)3}][B(hfip)₄] | Not tested | Soluble | |
| | | Xα = 0.044; | |
| | | Yield rate = 1.1 × | |
| | | 10⁻¹¹ mol/cm²/s; | |
| | | FE = 15%; | |
| | | Electrode = Fe on FTO | |
| | | Potential = −0.70 V vs | |
| | | Platinum pseudoreference | |
| [N_{2(2,O,2,O,1)3}][eFAP] | Soluble | Soluble | Soluble |
| | | Xα = 0.012 | Xα = 0.012 |
| | | Yield rate = 1.32 × | Yield rate = 1.85 × |
| | | 10⁻¹² mol/cm²/s | 10⁻¹¹ mol/cm²/s; |
| | | FE = 6%; | FE = 27%; |
| | | Electrode = Fe on FTO | Electrode = Fe on FTO |
| | | Potential = −0.6 V vs | Potential = −0.85 V vs |
| | | Ag/Ag+ | Ag/Ag+ |

| | | |
|---|---|---|
| [C₄mpyr][eFAP] | Soluble in mixture of solvents | Nil |
| | Xα = 0.18 ([FPEE:HFCP] [1:1]) | |
| | Yield rate = 3.3 × 10⁻¹² mol/cm²/s | |
| | FE = 4.7% | |

Comparative Examples

| | | | |
|---|---|---|---|
| [C₈H₄F₁₃dmim][C₄F₉SO₃] | Max Xα = 0.042. | Max Xα = 0.017 | No NH₃ |
| | No NH₃ produced | | produced in OFT |
| | | | Xα(OFT) = 0.031. |
| [C₈H₄F₁₃dmim][C₄F₉CO₂] | Max(Xα) = 0.032 | Max(Xα) = 0.14. | Nil |
| | | Xα = 0.080: | |
| | | Yield rate = 7.2 × | |
| | | 10⁻¹² mol/cm²/s; | |
| | | FE = 48%; | |
| | | Electrode = Fe on FTO | |
| | | Potential = −0.80 V vs | |
| | | Ag/Ag+ | |
| [C₄mpyr][eFAP] | Soluble | Soluble | PBSF, POSF, |
| | Xα = 0.23; | Xα = 0.10; | PFHex, PFOct, |
| | Yield rate = 2.35 × | Yield rate = 1.28 × | PFMD, OFHD |
| | 10⁻¹¹ mol/cm²/s; | 10⁻¹¹ mol/cm²/s; | did not usefully |
| | FE = 32% | FE = 10% | dissolve |
| | Electrode = α- | Electrode = α- | [C₄mpyr][eFAP]. |
| | Fe@Fe₃O₄ NR on | Fe@Fe₃O₄ NR on | |
| | CFP | CFP | |
| | Potential = −1.85 vs | Potential = −2.00 vs | |
| | Ag/Ag+. | Ag/Ag+ | |

Mixtures

| | | | |
|---|---|---|---|
| [P_{6,6,6,14}][eFAP] + | Soluble | Not tested. | Nil |
| [P_{6,6,6,14}][C₈F₁₇SO₃] | Xα = 0.07 + 0.08; | | |
| | Yield rate = 3.4 × | | |
| | 10⁻¹² mol/cm²/s; | | |
| | FE = 5.4% | | |
| | Electrode = Fe on FTO | | |
| | Potential = −2.0 V vs | | |
| | Ag/Ag+ | | |

### Compound Synthesis, Characterisation and Physicochemical Testing—Examples and Comparative Examples

The following examples set out the synthetic methods, characterisation and test results for the following compounds used in this study:

| | | |
|---|---|---|
| Example 1 | Trihexyltetradecylphosphonium | [P_{6,6,6,14}][C₄F₉CO₂] |
| | nonafluoropentanoate. | |
| Example 2 | Trihexyltetradecylphosphonium tridecafluorohexane | [P_{6,6,6,14}][C₆F₁₃SO₃] |
| | sulfonate | |
| Example 3 | 1-(3,3,4,4,5,5,6,6,7,7,8,8,8-tridecafluorooctyl)-3- | [C₈H₄F₁₃mim][C₄F₉SO₃] |
| | methylimidazolium nonafluorobutane sulfonate | |
| Example 4 | 1-(3,3,4,4,5,5,6,6,7,7,8,8,8-tridecafluorooctyl)-3- | [C₈H₄F₁₃mim][NTf₂] |
| | methylimidazolium bis [trifluoromethylsulfonyl]imide | |
| Example 5 | 1-(3,3,4,4,5,5,6,6,7,7,8,8,8-tridecafluorooctyl)-2,3- | [C₈H₄F₁₃dmim][eFAP] |
| | dimethyl imidazolium | |
| | tris(perfluoroethyl)trifluorophosphate | |
| Example 6 | 1-(3,3,4,4,5,5,6,6,7,7,8,8,8-tridecafluorooctyl)-2,3- | [C₈H₄F₁₃dmim][NTf₂] |
| | dimethylimidazolium bis(trifluoromethyl | |
| | sulfonyl)imide | |
| Example 7 | 1-(3,3,4,4,5,5,6,6,7,7,8,8,8-tridecafluorooctyl)-2,3- | [C₈H₄F₁₃dmim][C₄F₉SO₃] |
| | dimethylimidazolium nonafluorobutane sulfonate | |
| Example 8 | 1-methyl-pyrrolidinium pentadecafluorooctanoate | [Hmpyr][C₈F₁₅O₂] |
| Example 9 | 1-methyl-pyrrolidinium 1,1,2,2-tetrafluoro ethane | [Hmpyr][C₂H₂F₄SO₃] |
| | sulfonate | |
| Example 10 | 1-butyl-1-methylpyrrolidinium tetrakis(2,2,2- | [C₄mpyr][B(otfe)₄] |
| | trifluoroethoxy)borate | |
| Example 11 | 1-(4,4,5,5,6,6,7,7,8,8,9,9,10,10,11,11,11- | [C₁₁H₆F₁₇mpyr][CF₃SO₃] |
| | heptadecafluoroundecyl-1-methylpyrrolidinium | |
| | trifluoromethane sulfonate | |
| Example 12 | 1-(4,4,5,5,6,6,7,7,8,8,9,9,10,10,11,11,11- | [C₁₁H₆F₁₇mpyr][C₄F₉SO₃] |
| | heptadecafluoroundecyl-1-methylpyrrolidinium | |
| | nonafluorobutane sulfonate | |
| Example 13 | 1-(4,4,5,5,6,6,7,7,8,8,9,9,10,10,11,11,11- | [C₁₁H₆F₁₇mpyr][C₆F₁₃SO₃] |
| | heptadecafluoroundecyl-1-methylpyrrolidinium | |
| | tridecafluorohexane sulfonate | |
| Example 14 | 1-(4,4,5,5,6,6,7,7,8,8,9,9,10,10,11,11,11- | [C₁₁H₆F₁₇mpyr][C₈F₁₇SO₃] |
| | heptadecafluoroundecyl-1-methylpyrrolidinium | |
| | heptadecafluorooctane sulfonate | |
| Example 15 | 1-(3,3,4,4,5,5,6,6,7,7,8,8,8-tridecafluorooctyl)-2,3- | [C₈H₄F₁₃dmim][C₄F₉CO₂]. |
| | dimethylimidazolium nonafluoropentanoate | |
| Example 16 | Trihexyltetradecylphosphonium | [P_{6,6,6,14}][C₉F₁₇O₂] |
| | heptadecafluorononanoate | |
| Example 17 | 1-butyl-1-methylpyrrolidinium tris(perfluoroethyl) | [C₄mpyr][eFAP] |
| | trifluorophosphate | |
| Example 18 | 1-(2-methoxyethyl)-1-methyl pyrrolidinium | [C_{2,0,1}mpyr][eFAP] |
| | tris(perfluoroethyl)trifluorophosphate | |
| Example 19 | Trihexyltetradecylophosphonium nonafluoro butane | [P_{6,6,6,14}][C₄F₉SO₃] |
| | sulfonate | |
| Example 20 | Trihexyltetradecylphosphonium tetrakis(2,2,2- | [P_{6,6,6,14}][B(otfe)₄] |
| | trifluoroethoxy)borate | |
| Example 21 | Tributyl-(3,3,4,4,5,5,6,6,7,7,8,8,8-tridecafluorooctyl)- | [P_{4,4,4},Rf][C₄F₉SO₃] |
| | phosphonium nonafluorobutane sulfonate | Rf═C₈H₄F₁₃ |
| Example 22 | Tributyl-(3,3,4,4,5,5,6,6,7,7,8,8,8-tridecafluorooctyl)- | [P_{4,4,4},Rf][eFAP] |
| | phosphonium tris(perfluoroethyl)trifluorophosphate | Rf═C₈H₄F₁₃ |
| Example 23 | 1-ethyl-3-methylimidazolium nonafluorobutane | [C₂mim][C₄F₉SO₃] |
| | sulfonate | |
| Example 24 | 1-ethyl-3-methylimidazolium heptadecafluorooctane | [C₂mim][C₈F₁₇SO₃] |
| | sulfonate | |
| Example 25 | Trihexyltetradecylphosphonium nonafluoro | [P_{6,6,6,14}][C₄F₉CO₂] |
| | pentanoate | |
| Example 26 | Trihexyltetradecylphosphonium tridecafluorohexane | [P_{6,6,6,14}][C₆F₁₃SO₃] |
| | sulfonate | |
| Example 27 | Tributyl-(4,4,5,5,6,6,7,7,8,8,9,9,10,10,11,11,11- | [P_{4,4,4,Rf}][C₄F₉SO₃] |
| | heptadecafluoroundecyl)-phosphonium | Rf═C₁₁H₆F₁₇ |
| | nonafluorobutane sulfonate | |
| Example 28 | Tributyl-(4,4,5,5,6,6,7,7,8,8,9,9,10,10,11,11,11- | [P_{4,4,4,Rf}][eFAP], |
| | heptadecafluoroundecyl)- | Rf═C₁₁H₆F₁₇ |
| | phosphoniumtris(perfluoroethyl)trifluoro phosphate | |
| Example 29 | N-ethyl-N,N,N-tris(2-(2- | [N_{2(2,O,2,O,1)3}][B(hfip)₄] |
| | methoxyethoxy)ethyl)ammonium | |
| | tetrakis((1,1,1,3,3,3-hexafluoropropan-2- | |
| | yl)oxy)borate | |
| Example 31 | Trihexyl(4,4,5,5,6,6,7,7,8,8,9,9,10,10,11,11,11- | [N_{4,4,4},Rf][C₄F₉SO₃] |
| | heptadecafluoroundecyl)-ammonium | Rf═C₁₁H₆F₁₇ |
| | nonafluorobutane sulfonate | |
| Example 32 | N-ethyl-N,N,N-tris(2-(2- | [N_{2(2,O,2,O,1)3}][eFAP] |
| | methoxyethoxy)ethyl)ammonium tris(perfluoroethyl) | |
| | trifluorophosphate | |
| Example 33 | Trihexyltetradecylphosphonium tris(perfluoroethyl) | [P_{6,6,6,14}][eFAP] and |
| | trifluorophosphate and | [P_{6,6,6,14}][C₈F₁₇SO₃] |
| | Trihexyltetradecylphosphonium | |
| | heptadecafluorooctanesulfonate. | |
| Examples 34 to 36 | Liquid Flow Cell embodiments | |

In some of the following examples, solubility tests are carried out. Examples marked ‘A’ relate to mixtures with FPEE and Examples marked ‘B’ relate to mixtures with HFCP.

### Example 1: Full Name: Trihexyltetradecylphosphonium nonafluoropentanoate

Abbreviation: [P_{6,6,6,14}][C₄P₉CO₂].

Synthetic Procedure: The commercially available starting material, [P_{6,6,6,14}][Cl] (3.87 g, 7.45 mmol) was dissolved in 40 ml of distilled water at room temperature and nonafluoropentanoic acid (1.94 g, 7.42 mmol) was added. The reaction mixture was stirred for 24 h under nitrogen gas. The white cloudy solution was extracted with dichloromethane three times. The dichloromethane extract was washed with water five times followed by a single wash with potassium hydroxide (1 mM). Dichloromethane was removed in vacuo to afford a colourless liquid (4.91 g, 95%).

Characterisation—¹H NMR (400 MHz, CDCl₃) δ ppm: 0.85-0.93 (12H, t, 4CH₃), 1.25 (20H, m, 10CH₂), 1.27-1.35 (12H, m, 6CH₂), 1.39-1.55 (16H, m, 8CH₂), 2.12-2.24; ¹⁹F NMR (368 MHz, CDCl₃) δ ppm: −81.5 (3F, m, CF₃), −115.1 (2F, t, CF₂), −122.0 (2F, m, CF₂), −126.5 (2F, t, CF₂). ES-MS: ES+ m/z 483.5 P_{6,6,6,14}+, ES− m/z 263 C₅F₉O₂⁻, 219 C₅F₉⁻.

### Example 1A

Solubility: The solubility of [P_{6,6,6,14}][C₄F₉CO₂] in FPEE is Xα=>0.40.

Electrochemistry: The electrochemical method was the same as Example 5A except that the electrolyte was Xα 0.13 [P_{6,6,6,14}][C₄F₉CO₂] in FPEE. The reference electrode was Ag/Ag triflate dissolved in [C₄mpyr][eFAP]. A constant potential of −2V vs the reference electrode was applied for two hours to determine the NH₃ formation rate while the solution was bubbled with N₂ gas. The gas was then bubbled through two 1 mM H₂SO₄ traps to collect ammonia.

A yield rate of 2.14×10⁻¹² mol/cm²/s was found corresponding to a faradaic efficiency of 2.5%.

### Example 1B

Solubility: The solubility of [P_{6,6,6,14}][C₄F₉CO₂] in HFCP is Xα=>0.28.

Electrochemistry: The electrochemical method was the same as Example 5A except that the electrolyte was Xα 0.08 [P_{6,6,6,14}][C₄F₉CO₂] in HFCP. The reference electrode was Ag/Ag triflate dissolved in [C₄mpyr][eFAP]. A constant potential of −2V vs the reference electrode was applied for two hours to determine the NH₃ formation rate while the solution was bubbled with N₂ gas. The gas was then bubbled through two 1 mM H₂SO₄ traps to collect ammonia.

A yield rate of 2.2×10⁻¹² mol/cm²/s was found corresponding to a faradaic efficiency of 1.5%.

### Example 2: Full Name: Trihexyltetradecylphosphonium tridecafluorohexane sulfonate

Abbreviation: [P_{6,6,6,14}][C₆P₁₃SO₃].

Synthetic Procedure: see procedure for [P_{6,6,6,14}][C₅F₉O₂]. Potassium tridecafluorohexane sulfonate (3.04 g, 6.94 mmol) was added to [P_{6,6,6,14}][Cl] (3.59 g, 6.91 mmol), and water (40 mL), and after purification, afforded a colourless liquid (5.76 g, 96%).

Characterisation—¹H NMR (400 MHz, CDCl₃) δ ppm: 0.87-0.92 (12H, t, 4CH₃), 1.25 (20H, m, 10CH₂), 1.29-1.35 (12H, m, 6CH₂), 1.43-1.56 (16H, m, 8CH₂), 2.16-2.26; ¹⁹F NMR (368 MHz, CDCl₃) δ ppm: −81.3 (3F, t, CF₃), −114.9 (2F, t, CF₂), −121.1 (2F, m, CF₂) −122.3 (2F, m, CF₂), −123.3 (2F, m, CF₂), −126.6 (2F, m, CF₂). ES-MS: ES+ m/z 483.5 P_{6,6,6,14}+, ES− m/z 399 C₆F₁₃SO₃⁻.

### Example 2A

Solubility and Electrochemistry: Not tested, see Example 2B.

### Example 2B

Solubility: The solubility of [P_{6,6,6,14}][C₆F₁₃SO₃] in HFCP is Xα=>0.36.

Electrochemistry: The electrochemical method was the same as Example 5A except that the electrolyte was Xα 0.07. [P_{6,6,6,14}][C₆F₁₃SO₃] in HFCP. The reference electrode was Ag/Ag triflate dissolved in [C₄mpyr][eFAP]. A constant potential of −2V vs the reference electrode was applied for two hours to determine the NH₃ formation rate while the solution was bubbled with N₂ gas. The gas was then bubbled through two 1 mM H₂SO₄ traps to collect ammonia.

A yield rate of 2.5×10⁻¹² mol/cm²/s was found corresponding to a faradaic efficiency of 4.1%.

On the basis of this performance, a similar electrochemical result is anticipated for Example 2A.

### Example 3: Full Name: 1-(3,3,4,4,5,5,6,6,7,7,8,8,8-tridecafluorooctyl)-3-methylimidazolium nonafluorobutane sulfonate

Abbreviation: [C₈H₄F₁₃mim][C₄F₉SO₃] also known as [C₈H₄F₁₃mim][NfO].

[C₈H₄F₁₃mim][I] was synthesised according to literature methods (Almantariotis et al., The Journal of Physical Chemistry B 2010, 114 (10), 3608-3617).

Synthetic procedure (Quaternisation): Under inert conditions, [C₈H₄F₁₃mim][I] was prepared by dissolving a slight excess of methyl imidazole (2.64 g, 32.2 mmol) in dry toluene (40 mL) at room temperature. 1H,1H,2H,2H-perfluorooctyl iodide (14.6 g, 30.7 mmol) was added dropwise and shielded from light, over 30 minutes. The reaction mixture was stirred for 2 days at between 60° C. and 110° C. (reflux) after which it was cooled to 0° C. causing the formation of an orange solid. The solid was isolated via filtration and either washed with toluene and diethyl ether or recrystallised from acetonitrile and ethyl acetate at −20° C. The resulting pale yellow solid was dried in vacuo at 40° C. for 4 hours. Analysis showed the formation and isolation of [C₈H₄F₁₃mim][I] in (5.51 g, 33%).

Characterisation: ¹H NMR (400 MHz, (CD₃)₂CO) δ ppm: 3.12-3.24 (2H, m, CH₂), 4.12 (3H, s, CH₃), 4.90 (2H, t, CH₂), 7.82 (1H, t, CH), 8.01 (1H, t, CH), 9.56 (1H, s, NC(H)N); ¹⁹F NMR (368 MHz, (CD₃)₂CO) δ ppm: −81.7 (3F, d, CF₃), −122.4 (2F, s, CF₂), −123.4 (2F, s, CF₂), −124.0 (2F, s, CF₂), −126.8 (2F, s, CF₂). ES-MS: ES+ m/z 429 C₈H₄F₁₃mim+, ES− m/z 127 I—.

Synthetic Procedure (Metathesis): [C₈H₄F₁₃mim][I] (1.25 g, 2.26 mmol), was dissolved in 40 mL of distilled water at 60° C. and potassium nonfluorobutane sulfonate (0.80 g, 2.37 mmol) was added slowly. The stirring reaction mixture was heated to 85° C. for 2 h and then allowed to cool to room temperature for 12 h. A white precipitate formed and was isolated by filtration followed by drying in vacuo and analysis to show the formation of [C₈H₄F₁₃mim][C₄F₉SO₃] in (1.13 g, 68%).

Characterisation: ¹H NMR (400 MHz, (CD₃)₂CO) δ ppm: 3.06-3.19 (2H, m, CH₂), 4.10 (3H, s, CH₃), 4.85 (2H, t, CH₂), 7.78 (1H, t, CH), 7.96 (1H, t, CH), 9.28 (1H, s, NC(H)N); ¹⁹F NMR (368 MHz, (CD₃)₂CO) δ ppm: −81.7 (3F, t, CF₃), −81.9 (3F, t, CF₃), −114.4 (2F, t, CF₂), −115.6 (2F, t, CF₂), −122.1 (2F, s, CF₂), −122.4 (2F, s, CF₂), −123.4 (2F, s, CF₂), −124.1 (2F, s, CF₂), 126.3 (2F, t, CF₂), 126.8, (2F, s, CF₂). ES-MS: ES+ m/z 429 C₈H₄F₁₃mim+, ES− m/z 299 C₄F₉SO₃—.

### Example 4: Full Name: 1-(3,3,4,4,5,5,6,6,7,7,8,8,8-tridecafluorooctyl)-3-methylimidazolium bis [trifluoromethylsulfonyl]imide

Abbreviation: [C₈H₄F₁₃mim][NTf₂].

[C₈H₄F₁₃mim][NTf₂] was synthesised according to literature methods (Almantariotis, D.; Gefflaut, T.; Pádua, A. A. H.; Coxam, J. Y.; Costa Gomes, M. F., Effect of Fluorination and Size of the Alkyl Side-Chain on the Solubility of Carbon Dioxide in 1-Alkyl-3-methylimidazolium Bis(trifluoromethylsulfonyl)amide Ionic Liquids. The Journal of Physical Chemistry B 2010, 114 (10), 3608-3617).

Synthetic Procedure: [C₈H₄F₁₃mim][I] (4.00 g, 7.19 mmol, prepared via the synthetic procedure detailed in [C₈H₄F₁₃mim][C₄F₉SO₃]), was dissolved in 40 mL of distilled water at 60° C. and lithium NTf₂ (2.17 g, 7.55 mmol) was dissolved in 10 mL of water and added dropwise. The reaction mixture was allowed to cool to room temperature and stirred for 20 h after which an orange phase and a light yellow phase were observed. The water layer was decanted and the orange layer dissolved in dichloromethane and washed with water three times. After concentration of the dichloromethane layer to dryness and 2 h of drying in vacuo at 40° C. the orange liquid was analysed and found to be [C₈H₄F₁₃mim][NTf₂] (2.35 g, 46%).

Characterisation: ¹H NMR (400 MHz, (CD₃)₂CO) δ ppm: 3.06-3.19 (2H, m, CH₂), 4.11 (3H, s, CH₃), 4.86 (2H, t, CH₂), 7.78 (1H, t, CH), 7.95 (1H, t, CH), 9.22 (1H, s, NC(H)N); ¹⁹F NMR (368 MHz, (CD₃)₂CO) δ ppm: −80.0 (6F, s, (CF₃)₂), −81.7 (3F, s, CF₃), −114.5 (2F, t, CF₂), −114.4 (2F, t, CF₂), −122.4 (2F, s, CF₂), −123.4 (2F, s, CF₂), −124.1 (2F, s, CF₂), 126.8, (2F, s, CF₂). ES-MS: ES+ m/z 429 C₈H₄F₁₃mim+, ES− m/z 280 NTf₂⁻.

In a non-optimised electrochemical cell using this liquid salt as an electrolyte the ammonia yield rate was found to be 0.89 mg h⁻¹ m⁻².

### Example 5: Full Name: 1-(3,3,4,4,5,5,6,6,7,7,8,8,8-tridecafluorooctyl)-2,3-dimethyl imidazolium tris(perfluoroethyl)trifluorophosphate

Abbreviation: [C₈H₄F₁₃dmim][eFAP]

Synthetic procedure (Quaternisation): [C₈H₄F₁₃dmim][I] was synthesised according to literature methods replacing 1-methylimidazole with 1,2-dimethylimidazole. (Almantariotis et al., The Journal of Physical Chemistry B 2010, 114 (10), 3608). Analysis showed the formation and isolation of [C₈H₄F₁₃dmim][I] as a white powder in 5.4 g, 31% yield.

Characterisation: ¹H NMR (400 MHz, (CD₃)₂SO) δ ppm: 2.62 (3H, s, CH₃), 2.88-2.94 (2H, m, CH₂), 3.76 (3H, s, CH₃), 4.48-4.52 (2H, t CH₂), 7.66 (1H, d, CH), 7.75 (1H, d, CH); ¹⁹F NMR (368 MHz, (CD₃)₂SO, CClF₃) δ ppm: −125.28, (2F, s, CF₂), −122.57 (2F, s, CF₂), −121.17, (2F, s, CF₂), −121.22 (2F, s, CF₂), −112.57 (2F, s, CF₂), −79.76 (3F, t, CF₃). ES-MS: ES+ m/z 443 C₈H₄F₁₃dmim+, ES− m/z 127 I—

Synthetic procedure (Metathesis): [C₈H₄F₁₃dmim][I] (3.60 g, 6.33 mmol) was dissolved in 20 mL of acetonitrile. [C_{2,0,1}mpyr][eFAP] (3.73 g, 6.33 mmol), dissolved in 3 mL of acetonitrile and added slowly. The reaction solution was stirred at 74° C. for 5 days then stored at −28° C. overnight. A fine precipitate formed, the filtrate was isolated concentrated in vacuo and mostly dissolved in DCM. The DCM reaction mixture was filtered, the filtrate was washed 3 times with distilled water in a separation funnel. The DCM layer was concentrated in vacuo resulting in yellow and colourless crystalline solid found to be a mixture of [C₈H₄F₁₃dmim][eFAP] and approximately 25 mol % [C_{2,0,1}mpyr][eFAP] starting material in 1.72 g, 29% yield. Due to the absence of iodide, this mixture was deemed suitable for nitrogen reduction reaction trials without further purification.

Characterisation: ¹H NMR (400 MHz, (CD₃)₂SO) δ ppm: 2.06 (1H, br, CH₂CH₂ ring) 2.61 (3H, s, CH₃), 2.86-2.96 (2H, m, CH₂), 3.02 (0.8H, s, CH₃), 3.31 (0.8H, s, CH₃), 3.47-3.51 (1H, m, CH₂CH₂ ring) 3.54-3.57 (0.5H, m, CH₂), 3.76 (3H, s, CH₃), 4.48-4.52 (2H, t CH₂), 7.64 (1H, d, CH), 7.74 (1H, d, CH). (The integration ratios show [C_{2,0,1}mpyr] present in approximately 25 mol %). ¹⁹F NMR (368 MHz, (CD₃)₂SO) δ ppm: −125.88 (2F, s, CF₂), −123.15 (2F, s, CF₂), −122.74 (2F, s, CF₂), −121.78 (2F, s, CF₂), −116.23-−115.41 (7.6F, m, (CF₂)₃), −113.11 (2F, s, CF₂), −87.50 (2F, d, (F)₂), −81.18 (7.8F, s, (CF₃)₂), −80.40 (3F, t, CF₃), −79.62 (3F, m, CF₃), −44.23 (1.1F, dm, F). (The integration ratios show approximately 25 mol % more eFAP than [C₈H₄F₁₃dmim] owing to the remaining [C_{2,0,1}mpyr] cation remaining. ES-MS: ES+ m/z 144 [C_{2,0,1}mpyr]+, 443 C₈H₄F₁₃dmim+, ES−m/z 445 [eFAP]−

### Example 5A

Solubility: [C₈H₄F₁₃dmim][eFAP] shows a max Xα of 0.17 in FPEE at room temperature.

Electrochemistry: A three electrode electrochemical cell was used to perform N₂ reduction in an electrolyte of Xα=8.45×10⁻² [C₈H₄F₁₃dmim][eFAP] in FPEE.

The working electrode was electrodeposited Fe on FTO glass (surface area: 0.25 cm²), the counter electrode was a coiled platinum wire separated from the working electrode by a frit and the reference electrode was Ag/Ag triflate in the same electrolyte. To determine NH₃ formation rates a constant potential of −1.2V vs the reference electrode was applied for two hours while the solution was bubbled with N₂ gas. The gas was then bubbled through a 1 mM H₂SO₄ trap to collect ammonia. The trap and the electrolyte were then tested for ammonia.

A yield rate of 1.34×10⁻¹¹ moles of NH₃/cm²/s was found corresponding to a faradaic efficiency of 48%.

On the basis of this performance, we anticipate a similar electrochemical result for Example 5B (similar solubility), Examples 6A and 6B (identical cation and higher solubility).

### Example 5B

Solubility: [C₈H₄F₁₃dmim][eFAP] shows a maximum Xα 0.15 in HFCP at room temperature.

Electrochemistry: Not tested, see Example 5A.

### Example 6: Full Name: 1-(3,3,4,4,5,5,6,6,7,7,8,8,8-tridecafluorooctyl)-2,3-dimethylimidazolium bis(trifluoromethyl sulfonyl)imide

Abbreviation: [C₈H₄F₁₃dmim][NTf₂]

Synthetic procedure (Metathesis): [C₈H₄F₁₃dmim][I] (0.92 g, 1.61 mmol, prepared via the quaternisation synthetic procedure detailed in [C₈H₄F₁₃dmim][NTf₂], and LiNTf₂ (0.48 g, 1.69 mmol, 5% excess) was dissolved in 20 mL of methanol, heated to 50° C. and stirred for 2 days. The reaction solvent was removed in vacuo leaving a gooey, off white solid. The solid was dissolved in DCM, the solution heated to 37° C. overnight, followed by stirring at room temperature for 5 d affording a white solid in a yellow solution. The yellow filtrate was isolated and concentrated in vacuo leaving a pale yellow liquid found to be [C₈H₄F₁₃dmim][NTf₂] in 0.58 g, 50% yield.

Characterisation: ¹H NMR (400 MHz, (CD₃)₂SO) δ ppm: 2.61 (3H, s, CH₃), 2.84-2.98 (2H, m, CH₂), 3.76 (3H, s, CH₃), 4.47-4.51 (2H, t CH₂), 7.63 (1H, d, CH), 7.73 (1H, d, CH); ¹⁹F NMR (368 MHz, (CD₃)₂SO) δ ppm: −125.76 (2F, s, CF₂), −123.07 (2F, s, CF₂), −122.65, (2F, s, CF₂), −121.70, (2F, s, CF₂), −113.06 (2F, s, CF₂) −80.24 (3F, s, CF₃), −78.76 (6F, s, (CF₃)₂). ES-MS: ES+ m/z 443 C₈H₄F₁₃dmim+, ES− m/z 280 [NTf₂]−.

### Example 6A

Solubility: [C₈H₄F₁₃dmim][NTf₂] shows a max Xα of 0.11 or 0.23 mol/L in FPEE at room temperature.

Electrochemistry: Not tested, see Example 5A.

### Example 6B

Solubility: The solubility of [C₈H₄F₁₃dmim][NTf₂] in HFCP is Xα=>0.22 or >2.4 mol/L.

Electrochemistry: Not tested, see Example 5A.

### Example 7: Full Name: 1-(3,3,4,4,5,5,6,6,7,7,8,8,8-tridecafluorooctyl)-2,3-dimethylimidazolium nonafluorobutane sulfonate

Abbreviation: [C₈H₄F₁₃dmim][C₄F₉SO₃].

Synthetic procedure (Metathesis): [C₈H₄F₁₃dmim][I] (1.40 g, 2.52 mmol, prepared via the quaternisation synthetic procedure detailed in [C₈H₄F₁₃dmim][eFAP]) and K[C₄F₉SO₃] (0.90 g, 2.65 mmol) were stirred together in 30 ml of DCM at 35° C. After 3 d, the reaction mixture was cooled to room temperature and a white powder precipitated from the pale yellow DCM solution. The powder was isolated via filtration, washed with distilled water, dried under vacuum and found to be [C₈H₄F₁₃dmim][C₄F₉SO₃] in 0.55 g, 29% yield.

Characterisation: ¹H NMR (400 MHz, (CD₃)₂SO) δ ppm: 2.62 (3H, s, CH₃), 2.87-2.96 (2H, m, CH₂), 3.76 (3H, s, CH₃), 4.48-4.52 (2H, t CH₂), 7.64 (1H, d, CH), 7.74 (1H, d, CH); ¹⁹F NMR (368 MHz, (CD₃)₂SO) δ ppm: −125.26, (4F, m, CF₂), −122.62, (2F, s, CF₂), −122.21 (2F, s, CF₂), −121.25, (2F, s, CF₂), −120.94 (2F, s, CF₂), −114.39, (2F, s, CF₂), −112.61 (2F, s, CF₂) −80.05 (3F, s, CF₃), −79.84 (3F, s, CF₃). ES-MS: ES+ m/z 443 C₈H₄F₁₃dmim+, ES− m/z 299 [C₄F₉SO₃]—

### Example 7A

Solubility: [C₈H₄F₁₃dmim][C₄F₉SO₃] shows a max Xα of 0.04 in FPEE at room temperature.

Electrochemistry: The electrochemical method was the same as Example 5A except that the electrolyte was Xα=4.2×10⁻² [C₈H₄F₁₃dmim][C₄F₉SO₃] in FPEE. No significant amount of ammonia was detected in either the trap or the electrolyte.

On the basis of this performance, the inventors anticipate a similar electrochemical result for Examples 7B and 8A.

### Example 7B

Solubility: [C₈H₄F₁₃dmim][C₄F₉SO₃] shows max Xα of 0.017 in HFCP at room temperature.

Electrochemistry: Not tested; see Example 7A.

### Example 8: Full Name: 1-methyl-pyrrolidinium pentadecafluorooctanoate

Abbreviation: [Hmpyr][C₈F₁₅O₂]

Synthetic Procedure: Perfluorooctanoic acid (1.90 g, 4.59 mmol) was added to N-methylpyrrolidine (0.45 g, 5.28 mmol). Once the exothermic reaction was complete, the reaction mixture was allowed to warm to room temperature and stirred for 24 hours under nitrogen. The product was concentrated in vacuo to afford a light green gel-like liquid (2.00 g, 50%).

Characterisation: ¹H NMR (400 MHz, CDCl₃) δ ppm: 2.07-2.20 (4H, m, 2CH₂), 2.75-2.80 (2H, m, CH₂), 2.86-2.87 (3H, d, CH₃), 3.82-3.85 (2H, m, CH₂), 13.12-13.18 (H, m, NH); ¹⁹F NMR (368 MHz, CDCl₃) δ ppm: −126.1 (2F, m, CF₂), −122.7 (2F, m, CF₂), −122.0 (4F, m, 2CF₂), −121.8 (2F, m, CF₂), −117.2 (2F, m, CF₂), −80.8 (3F, t, CF₃). ES-MS: ES+ m/z 86 Hmpyr+, ES− m/z 412 C₈F₁₅O²⁻, 369 C₇F₁₅⁻, 219 C₄F9⁻, 169 C₃F₇⁻, 119 C₂F₅

### Example 9: Full Name: 1-methyl-pyrrolidinium 1,1,2,2-tetrafluoroethane sulfonate

Abbreviation: [Hmpyr][C₂H₂F₄SO₃].

Synthetic Procedure: 2-H-perfluoroethylsulfonic acid (2.27 g, 12.5 mmol) was added to N-methylpyrrolidine (1.11 g, 13.0 mmol) neat, and after drying in vacuo, afforded a white solid (2.0 g, 50%).

Characterisation: ¹H NMR (400 MHz, CDCl₃) δ ppm: 2.13-2.22 (4H, m, 2CH₂), 2.87-2.92 (2H, m, CH₂), 2.94-2.95 (3H, d, CH₃), 3.79-3.85 (2H, m, CH₂), 9.55 (H, m, NH); ¹⁹F NMR (368 MHz, CDCl₃) δ ppm: −135.7 (2F, (doublet of)t, CF₂), −123.1 (2F, m, CF₂). MS: ES+ m/z 87 Hmpyr+, ES− m/z 181 C₂H₂F₄SO³⁻

### Example 10: Full Name: 1-butyl-1-methy 1pyrrolidinium tetrakis(2,2,2-trifluoroethoxy)borate

Abbreviation: [C₄mpyr][B(otfe)₄].

Synthetic Procedure: [Na][B(otfe)₄] was synthesised according to literature (Rupp et al, ChemPhysChem 2014, 15 (17), 3729-3731). NaBH₄ (2.00 g, 53 mmol) was added to dimethoxyethane (22 mL) and toluene (50 mL). Trifluoroethanol (31.6 g, 316 mmol) was added dropwise over one hour under an acetone/dry ice bath (−15° C.). The mixture was heated to reflux overnight under N₂. After purification, afforded a white powder (18 g, 83%).

Characterisation: ¹H NMR (400 MHz, CD₃CN) δ ppm: 3.67-3.77 (8H, q, 4CH₂); ¹⁹F NMR (368 MHz, (CD₃)₂SO) δ ppm: −74.3 (12F, t, 4CF₃). ES-MS: ES− m/z no anion detected.

Synthetic Procedure (Metathesis): [C₄mpyr][Br] (2.06 g, 9.3 mmol) was dissolved in dry acetonitrile (120 mL) and [Na][B(otfe)₄] (4.00 g, 9.3 mmol) was added. Under a nitrogen atmosphere, the reaction mixture was stirred at room temperature for 70 h. The acetonitrile was removed in vacuo and DCM (100 mL) was added to the white solid and left to stir for one hour. The white solid was filtered under N₂ and dried in vacuo to afford a white powder (4.03 g, 79%).

Characterisation: ¹H NMR (400 MHz, CD₃CN) δ ppm: 0.95-0.99 (3H, t, CH₃), 1.23-1.42 (2H, m, CH₂), 1.70-1.74 (2H, t, CH₂), 2.15 (4H, m, 2CH₂), 2.93 (3H, s, N—CH₃), 3.20-3.24 (2H, m, N—CH₂), 3.37-3.41 (4H, m, N—CH₂), 3.68-3.76 (5H, q, 4CH₂); ¹⁹F NMR (368 MHz, (CD₃)₂SO) δ ppm: −74.3 (12F, t, 4CF₃). ES-MS: ES+ m/z 142 C₄mpyr+, ES− no anion detected.

### Example 11: Full Name: 1-(4,4,5,5,6,6,7,7,8,8,9,9,10,10,11,11,11-heptadecafluoroundecyl-1-methylpyrrolidinium trifluoromethane sulfonate

Abbreviation: [C₁₁H₆F₁₇mpyr][CF₃SO₃].\

Synthetic Procedure (Quaternisation): Under inert conditions, 1-(4,4,5,5,6,6,7,7,8,8,9,9,10,10,11,11,11-heptadecafluoroundecyl-1-methylpyrrolidiniumiodide ([C₁₁H₆F₁₇mpyr][I]) was prepared by dissolving methyl pyrrolidine (0.263 g, 3.09 mmol) in dry acetonitrile at 50° C. Commercially available 1,1,1,2,2,3,3,4,4,5,5,6,6,7,7,8,8-heptadecafluoro-11-iodoundecane (2.00 g, 3.40 mmol) was added in 10% excess, dropwise and shielded from light, over 30 minutes. The reaction mixture was stirred for 48 h at 50° C., still being shielded from light, after which it was cooled to room temperature. The acetonitrile was removed in vacuo, and the resulting solid was dissolved in dichloromethane (200 mL). The solution was then wash with distilled water (100 mL) three times and the dichloromethane was removed in vacuo yielding a white solid. Analysis showed the formation of [C₁₁H₆F₁₇mpyr][I] (1.28 g, 61.7%).

Characterisation: ¹H NMR (400 MHz CDCl₃): δ (ppm) 2.22 (m, 8H), 3.38 (s, 3H), 3.80 (m, 2H), 4.00 (m, 4H); ¹⁹F NMR (376.5 MHz CDCl₃): δ (ppm) −80.9 (s, 3H), −113.8 (s, 2H), −122.0 (s, 6H), −122.8 (s, 2H), −123.2 (s, 2H), −126.2 (s, 2H). ES-MS: ES+ m/z 546 C₁₁H₆F₁₇mpyr+, ES− m/z 127 I—.

Synthetic Procedure (Metathesis): [C₁₁H₆F₁₇mpyr][I] (1.28 g, 1.91 mmol), was dissolved in 30 ml of dry acetone at reflux. Silver trifluoromethane sulfonate (0.490 g, 1.91 mmol) was added in equal molar ratio. The reaction mixture was stirred for 4h, following this the solution was filtered. The acetone was removed from the filtrate in vacuo to yield a pale yellow to white solid that was washed with 20 mL of distilled water three times. The solid was then dried to remove excess water, and was shown by analysis to be [C₁₁H₆F₁₇mpyr][CF₃SO₃] (1.21 g, 91.2%).

Characterisation: ¹H NMR (400 MHz, (CD₃)₂CO): δ (ppm) 2.40 (m, 8H), 3.40 (s, 3H), 3.87 (m, 6H); ¹⁹F NMR (368 MHz, (CD₃)₂CO): δ (ppm) −78.9 (s, 3F), −81.6 (s, 3F), −114.5 (s, 2F), −122.4 (s 6F), −123.2 (s, 2F), −124.0 (2, 2F), −127.0 (s, 2F). ES-MS: ES+ m/z 546 C₁₁H₆F₁₇mpyr+, ES− m/z 149 CF₃SO³⁻.

### Example 12: Full Name: 1-(4,4,5,5,6,6,7,7,8,8,9,9,10,10,11,11,11-heptadecafluoroundecyl-1-methylpyrrolidinium nonafluorobutane sulfonate

Abbreviation: [C₁₁H₆F₁₇mpyr][C₄F₉SO₃] also known as [C₁₁H₆F₁₇mpyr][NfO].

Synthetic Procedure: see procedure for [C₁₁H₆F₁₇mpyr][CF₃SO₃]. Potassium nonafluorobutane sulfonate (0.646 g, 1.91 mmol) was added to [C₁₁H₆F₁₇mpyr][I] (1.283 g, 1.91 mmol) dissolved in 30 ml of dry acetone at reflux. After purification a pale yellow to white solid was afforded and shown by analysis to be [C₁₁H₆F₁₇mpyr][C₄F₉SO₃] (1.44 g, 89.0%).

Characterisation: ¹H NMR (400 MHz, (CD₃)₂CO): δ (ppm) 2.39 (m, 8H), 3.40 (s, 3H), 3.87 (m, 6H); ¹⁹F NMR (368 MHz, (CD₃)₂CO): δ (ppm) −81.6 (s, 3F), −81.9 (s, 3F), −114.5 (s, 2F), −115.5 (s, 2F), −122.1 (s, 8F), −123.2 (s, 2F), −124.0 (s, 2F), −126.7 (s, 4F). ES-MS: ES+ m/z 546 C₁₁H₆F₁₇mpyr+, ES− m/z 299 C₄F₉SO³⁻.

### Example 13: Full Name: 1-(4,4,5,5,6,6,7,7,8,8,9,9,10,10,11,11,11-heptadecafluoroundecyl-1-methylpyrrolidinium tridecafluorohexane sulfonate

Abbreviation: [C₁₁H₆F₁₇mpyr][C₆F₁₃SO₃].

Synthetic Procedure: see procedure for [C₁₁H₆F₁₇mpyr][CF₃SO₃]. Potassium tridecafluorohexane sulfonate (0.835 g, 1.91 mmol) was added to [C₁₁H₆F₁₇mpyr][I] (1.283 g, 1.91 mmol) dissolved in 30 ml of dry acetone at reflux. After purification a pale yellow to white solid was afforded and shown by analysis to be [C₁₁H₆F₁₇mpyr][C₆F₁₃SO₃] (1.23 g, 68.4%).

Characterisation: ¹H NMR (400 MHz, (CD₃)₂CO): δ (ppm) 2.40 (m, 8H), 3.41 (s, 3H), 3.88 (m, 6H); ¹⁹F NMR (368 MHz, (CD₃)₂CO): δ (ppm) −81.6 (s, 3F), −81.7 (s, 3F), −114.5 (s, 2F), −115.2 (s, 2F), −121.1 (s, 2F), −122.4 (s, 8F), −123.4 (s, 4F), −124.1 (s, 2F), −126.7 (s, 4F). ES-MS: ES+ m/z 546 C₁₁H₆F₁₇mpyr+, ES− m/z 399 C₆F₁₃SO³⁻.

### Example 14: Full Name: 1-(4,4,5,5,6,6,7,7,8,8,9,9,10,10,11,11,11-heptadecafluoroundecyl-1-methylpyrrolidinium heptadecafluorooctane sulfonate

Abbreviation: [C₁₁H₆F₁₇mpyr][C₈F₁₇SO₃] also known as [C₁₁H₆F₁₇mpyr][PFO].

Synthetic Procedure: see procedure for [C₁₁H₆F₁₇mpyr][CF₃SO₃]. Potassium heptadecafluorooctane sulfonate (1.03 g, 1.91 mmol) was added to [C₁₁H₆F₁₇mpyr][I] (1.283 g, 1.91 mmol) dissolved in 30 ml of dry acetone at reflux. After purification a pale yellow to white solid was afforded and shown by analysis to be [C₁₁H₆F₁₇mpyr][C₈F₁₇SO₃] (1.55 g, 77.5%).

Characterisation: ¹H NMR (400 MHz, (CD₃)₂CO): δ (ppm) 2.40 (m, 8H), 3.40 (s, 3H), 3.88 (m, 6H); ¹⁹F NMR (368 MHz, (CD₃)₂CO): δ (ppm) −81.4 (s, 3F), −81.9 (s, 3F), −114.6 (s, 2F), −115.4 (s, 2F), −121.1 (s, 2F), −122.7 (s, 12F), −123.5 (s, 4F), −124.1 (s, 2F), −126.7 (s, 4F). ES-MS: ES+ m/z 546 C₁₁H₆F₁₇mpyr+, ES− m/z 499 C₈F₁₇SO³⁻.

### Example 15: Full Name: 1-(3,3,4,4,5,5,6,6,7,7,8,8,8-tridecafluorooctyl)-2,3-dimethylimidazolium nonafluoropentanoate

Abbreviation: [C₈H₄F₁₃dmim][C₄F₉CO₂].

Synthetic procedure (Metathesis): [C₈H₄F₁₃dmim][I] (2.29 g, 4.02 mmol prepared via the quaternisation synthetic procedure detailed in [C₈H₄F₁₃dmim][eFAP]), was dissolved in 10 mL of MeOH and slowly passed through a freshly prepared amberlyst ion exchange column. 100 percent conversion to [C₈H₄F₁₃dmim][OH] was assumed. Nonafluoropentanoic acid (1.06 g, 4.02 mmol) was added to the [C₈H₄F₁₃dmim][OH] in MeOH solution and the reaction mixture was stirred at room temperature overnight followed by heating to 52° C. for 2 h. A yellow viscous layer was observed at the bottom of the reaction flask, isolated with a pasteur pipette, concentrated in vacuo leaving an off white power that was found to be [C₈H₄F₁₃dmim][C₄F₉CO₂] in 1.08 g, 38% yield.

Characterisation: ¹H NMR (400 MHz, (CD₃)₂SO) δ ppm: 2.62 (3H, s, CH₃), 2.85-2.98 (2H, m, CH₂), 3.76 (3H, s, CH₃), 4.48-4.52 (2H, t CH₂), 7.65 (1H, d, CH), 7.75 (1H, d, CH); ¹⁹F NMR (368 MHz, (CD₃)₂SO) δ ppm: −125.37 (2F, s, CF₂), −125.05 (2F, s, CF₂), −122.64, (2F, s, CF₂), −122.18, (4F, d, CF₂), −121.27 (2F, s, CF₂), −114.72 (2F, s, CF₂), −112.64 (2F, t, CF₂) −80.19 (3F, t, CF₃), −78.87 (3F, s, (CF₃)₂). ES-MS: ES+ m/z 443 C₈H₄F₁₃dmim+, ES− m/z 263 [C₄F₉CO₂]—, 219 [C₄F₉]—.

### Example 15A

Solubility: [C₈H₄F₁₃dmim][C₄F₉CO₂] shows max Xα of 0.032 in FPEE at room temperature.

Electrochemistry: Not tested. See example 15B.

### Example 15B

Solubility: [C₈H₄F₁₃dmim][C₄F₉CO₂] shows a max Xα of 0.14 in HFCP at room temperature.

Electrochemistry: The electrochemical method was the same as Example 5A except that the electrolyte was XA 0.8 [C₈H₄F₁₃dmim][C₄F₉COO] in HFCP. A constant potential of −0.8 V vs the reference electrode was applied for 1 hour and 45 minutes to determine the NH₃ formation rate. On the basis of this and subsequent performances at lower concentrations, the inventors anticipate a similar electrochemical result for Example 15A.

A rate of 7.2×10⁻¹² moles of NH₃/cm²/s was found corresponding to a faradaic efficiency of 48%.

### Example 16: Full Name: Trihexyltetradecylphosphonium heptadecafluorononanoate

Abbreviation: [P_{6,6,6,14}][C₉F₁₇O₂].

Synthetic Procedure: see procedure for [P_{6,6,6,14}][C₅F₉O₂]. Heptadecanonanoic acid (2.54 g, 5.47 mmol) was added to [P_{6,6,6,14}][Cl] (2.84 g, 5.47 mmol) and water (40 mL), and after purification, afforded a colourless liquid (5.04 g, 84%).

Characterisation—^{1H} NMR (400 MHz, CDCl₃) δ ppm: 0.85-0.92 (12H, t, 4CH₃), 1.25 (20H, m, 10CH₂), 1.28-1.35 (12H, m, 6CH₂), 1.42-1.56 (16H, m, 8CH₂), 2.26-2.36; ¹⁹F NMR (368 MHz, CDCl₃) δ ppm: −81.3 (3F, t, CF₃), −116.7 (2F, t, CF₂), −122.1 (2F, m, CF₂) −122.4 (4F, m, CF₂CF₂), −122.6 (2F, m, CF₂), −123.2 (2F, m, CF₂), −126.6 (2F, m, CF₂). ES-MS: ES+ m/z 483.5 P_{6,6,6,14}+, ES− m/z 463 C₉F₁₇O₂—, 419 C₉F₁₇—, 269 C₅F₁₁—, 219 C₄F₉—, 169 C₃F₇—.

### Example 17: Full Name: 1-butyl-1-methylpyrrolidinium tris(perfluoroethyl) trifluorophosphate

Abbreviation: [C₄mpyr][eFAP].

This compound was commercially available.

### Example 17A

Solubility: [C₄mpyr][eFAP] was tested at Xα of 0.35 in FPEE.

Electrochemistry: The electrochemical method was the same as Example 5A except that the electrolyte was Xα 2.3×10⁻¹ [C₄mpyr][eFAP] in FPEE. The working electrode was α-Fe@Fe₃O₄ NR on CFP (surface area: 0.25 cm²). A constant potential of −1.85V vs the reference electrode was applied for one hour to determine the NH₃ formation rate.

A yield rate of 2.35×10⁻¹¹ moles of NH₃/cm²/s was found corresponding to a faradaic efficiency of 32%.

On the basis of this performance, a similar is anticipated electrochemical result for Example 28A.

### Example 17B

Solubility: [C₄mpyr][eFAP] was tested at Xα of 0.35 in HFCP.

Electrochemistry: The electrochemical method was the same as Example 5A except that the electrolyte was Xα 1.0×10⁻¹ [C₄mpyr][eFAP] in HFCP. The working electrode was α-Fe@Fe₃O₄ NR on CFP (surface area: 0.25 cm²). A constant potential of −2.0V vs the reference electrode was applied for one hour to determine the NH₃ formation rate.

A yield rate of 1.28×10⁻¹¹ moles of NH₃/cm²/s was found corresponding to a faradaic efficiency of 10.35%.

On the basis of this performance, a similar electrochemical result is anticipated for Example 28B.

### Example 18: Full Name: 1-(2-methoxyethyl)-1-methyl pyrrolidinium tris(penta fluoro)trifluorophosphate

Abbreviation: [C_{2,0,1}mpyr][eFAP].

This compound was commercially available.

### Example 18A

Solubility and electrochemistry: Not tested, see Example 18B

### Example 18B

Solubility: [C_{2,0,1}mpyr][eFAP] was tested at Xα of 0.35 in HFCP.

Electrochemistry: The electrochemical method was the same as Example 5A except for the following parameters. The electrolyte was Xα 3.5×10⁻¹ [C_{2,O,1}mpyr][eFAP] in HFCP. The working electrode was α-Fe@Fe₃O₄ NR on CFP (surface area: 0.25 cm²). A constant potential of −1.85V vs the reference electrode was applied for one hour to determine the NH₃ formation rate.

A yield rate of 1.90×10⁻¹¹ moles of NH₃/cm²/s was found corresponding to a faradaic efficiency of 12%.

On the basis of this performance, the inventors anticipate a similar electrochemical result for Example 18A.

### Example 19: Full Name: Trihexyltetradecylophosphonium nonafluoro butane sulfonate

Abbreviation: [P_{6,6,6,14}][C₄P₉SO₃].

Synthesis (metathesis): See procedure for [P_{6,6,6,14}][C₄F₉CO₂]. [[P_{6,6,6,14}][Cl] (3.84 g, 6.76 mmol) was added to potassium nonafluorobutanesulfonate (2.32 g, 6.86 mmol), DCM (˜40 mL) and water (40 mL). After extraction, DCM was removed in vacuo to afford a colourless oil (2.93 g, 74%).

Characterisation: ¹H NMR (400 MHz, CDCl₃) δ ppm: 1H NMR (400 MHz, CDCl₃) δ ppm: 0.84-0.88 (12H, t, 4CH₃), 1.23 (20H, m, 10CH₂), 1.26-1.29 (12H, m, 6CH₂), 1.33-1.40 (8H, m, 4CH₂), 2.19-2.27 (8H, m, 4CH₂), 3.72-3.85, (8H, m, 4CH₂); ¹⁹F NMR (400 MHz, DMSO) δ ppm: 125.68-(−125.57) (2F, t, CF₂), −121.39-(−121.31) (2F, m, CF₂), −114.83-(−114.76) (2F, t, CF₂), 80.42 (80.37) (3F, m, CF₃). ES-MS: ES+ m/z 483 P_{6,6,6,14}+, ES− m/z 499 [C₄F₉SO₃]—

### Example 19A

Solubility: The solubility of [P_{6,6,6,14}][C₄F₉SO₃] in FPEE is Xα=>0.39.

Electrochemistry: The electrochemical method was the same as Example 5A except that the electrolyte was Xα 0.17 [P_{6,6,6,14}][C₄F₉SO₃] in FPEE. The reference electrode was Ag/Ag triflate in [C₄mpyr][eFAP]. A constant potential of −2V vs the reference electrode was applied for two hours to determine the NH₃ formation rate. Two 1 mM H₂SO₄ traps were used to collect ammonia.

A yield rate of 5.3×10⁻¹² mol/cm²/s was found corresponding to a faradaic efficiency of 15%.

On the basis of this performance, the inventors anticipate a similar electrochemical result for Example 26B.

### Example 19B

Solubility and Electrochemistry: Not tested. See Example 26B.

### Example 20: Full Name: Trihexyltetradecylphosphonium tetrakis(2,2,2-trifluoroethoxy)borate

Abbreviation: [P_{6,6,6,14}][B(Otfe)₄].

Synthetic Procedure: see procedure for [C₄mpyr][B(otfe)₄]. [Na][B(otfe)₄] (1.94 g, 4.5 mmol) was added to trihexyltetradecylphosphonium chloride (2.34 g, 4.5 mmol) and acetonitrile (50 mL) and after purification, afforded an opaque gel-like solid (3.74 g, 93%).

Characterisation: ¹H NMR (400 MHz, CDCl₃) δ ppm: 0.85-0.93 (12H, t, 4CH₃), 1.26 (20H, m, 10CH₂), 1.29-1.35 (12H, m, 6CH₂), 1.41-1.55 (16H, m, 8CH₂), 2.17-2.29 (8H, m, 4CH₂), 3.71-3.86, (8H, m, 4CH₂); ¹⁹F NMR (368 MHz, CDCl₃) δ ppm: −77.0 (12F, t, 4CF₃). ES-MS: ES+ m/z 483.5 P_{6,6,6,14}+, ES− anion not observed.

### Example 21: Full Name: Tributyl-(3,3,4,4,5,5,6,6,7,7,8,8,8-tridecafluorooctyl)-phosphonium nonafluorobutane sulfonate

Abbreviation: [P_{4,4,4},Rf][C₄F₉SO₃], Rf═C₈H₄F₁₃.

Synthetic Procedure—[P_{4,4,4},Rf][I] was synthesised according to literature methods (Tindale et al Canadian Journal of Chemistry 2007, 85, 660+). Tributylphosphine (2.44 g, 12.1 mmol) was added to 1H,1H,2H,2H-perfluorooctyl iodide (5.71 g, 12.3 mmol) and stirred under N₂ for 48 hours. Any residual starting material was removed in vacuo at 40° C.

[P_{4,4,4},Rf][C₄F₉SO₃] see procedure for [P_{6,6,6,14}][C₅F₉O₂]. [P_{4,4,4},Rf][I] (3.01 g, 4.44 mmol) was added to potassium nonafluorobutanesulfonate (1.60 g, 4.70 mmol) and water (40 mL), and after purification, afforded a light yellow liquid (3.22 g, 85%).

Characterisation: ¹H NMR (400 MHz, (CD₃)₂SO) δ ppm: 0.88-0.99 (9H, t, 3CH₃), 1.36-1.58 (12H, m, 6CH₂), 1.60-1.70 (2H, m, CH₂), 2.12-2.56 (8H, m, 4CH₂). ¹⁹F NMR (368 MHz, CDCl₃) δ ppm: [P_{4,4,4},Rf]−80.8 (3F, m, CF₃), −114.3 (2F, m, CF₂), −121.8 (2F, m, CF₂) −122.8 (4F, m, CF₂CF₂), −123.3 (2F, m, CF₂), −126.1 (2F, m, CF₂). [C₄F₉SO₃]— −81.0 (3F, t, CF₃), −114.7 (2F, t, CF₂), −121.6 (2F, m, CF₂) −126.1 (2F, m, CF₂). ES-MS: ES+ m/z 549 P_{4,4,4},Rf+, ES− m/z 299 C₄F₉SO₃—.

In a non-optimised electrochemical cell using this liquid salt as an electrolyte the ammonia yield rate was found to be 1.1 mg h⁻¹ m⁻².

### Example 22: Full Name: Tributyl-(3,3,4,4,5,5,6,6,7,7,8,8,8-tridecafluorooctyl)-phosphonium tris(perfluoroethyl)trifluorophosphate

Abbreviation: [P_{4,4,4},Rf][eFAP], Rf═C₈H₄F₁₃. Synthetic Procedure: see procedure for [P_{6,6,6,14}][C₅F₉O₂]. [P_{4,4,4},Rf][I] (2.64 g, 3.90 mmol) was added to 1-(2-Methoxyethyl)-1-methylpyrrolidinium. Tris(pentafluoroethyl)trifluorophosphate (2.31 g, 3.92 mmol), and after purification, afforded a light yellow liquid (3.71 g, 96%).

Characterisation—¹H NMR (400 MHz, (CD₃)₂SO) δ ppm: 0.86-1.01 (9H, t, 3CH₃), 1.36-1.56 (12H, m, 6CH₂), 1.63-1.71 (2H, m, CH₂), 1.98-2.40 (8H, m, 4CH₂); ¹⁹F NMR (368 MHz, (CD₃)₂SO) δ ppm: [P_{4,4,4},Rf]− −80.4 (3F, m, CF₃), −113.9 (2F, m, CF₂), −121.8 (2F, m, CF₂) −122.4 (4F, m, CF₂CF₂), −122.7 (2F, m, CF₂), −125.9 (2F, m, CF₂). [eFAP]− −113.8 (4F, m, 2CF₂), −115.7 (2F, m, CF₂), −88.7+86.2) (2F, m, 2PF), −81.1 (6F, m, 2CF₃), −79.6 (3F, m, C₂F₅), −43.5-(−45.0) (1F, m, PF). ES-MS: ES+ m/z 483 P_{6,6,6,14}+, ES− m/z 445 eFAP−.

### Example 23: Full Name: 1-ethyl-3-methylimidazolium nonafluorobutane sulfonate

Abbreviation: [C₂mim][C₄F₉SO₃] also known as [C₂mim][NfO].

Synthetic Procedure: see procedure for [P_{6,6,6,14}][C₅F₉O₂]. 1-ethyl-3-methylimidazolium bromide (1.98 g, 10.36 mmol) was added to potassium nonafluorobutanesulfonate (3.54 g, 10.47 mmol) and water (40 mL), and after purification, to afford an opaque liquid (2.3 g, 54%).

Characterisation: ¹H NMR (400 MHz, CDCl₃) δ ppm: 1.54-1.57 (3H, t, CH₃), 3.97 (3H, s, CH₃), 4.24-4.30 (2H, q, CH₂), 7.31-7.32 (2H, m, 2CH), 9.17 (H, s, CH); ¹⁹F NMR (368 MHz, CDCl₃) δ ppm: −126.0 (2F, m, CF₂), −121.7 (2F, m, CF₂), −114.9 (2F, m, CF₂), −80.9 (3F, t, CF₃). ES-MS: ES+ m/z 111 C₂mim+, ES− m/z 299 C₄F₉SO₃—.

### Example 24: Full Name: 1-ethyl-3-methylimidazolium heptadecafluorooctane sulfonate

Abbreviation: [C₂mim][C₈F₁₇SO₃] also known as [C₂mim][PFO].

Synthetic Procedure: see procedure for [P_{6,6,6,14}][C₅F₉O₂]. 1-ethyl-3-methylimidazolium bromide (2.25 g, 4.18 mmol) was added to potassium heptadecafluorooctanesulfonate (0.82 g, 4.19 mmol) and water (40 mL), and after purification, afforded a colourless solid. (0.50 g, 25%).

¹H NMR (400 MHz, CDCl₃) δ ppm: 1.58-1.62 (3H, t, CH₃), 4.02 (3H, s, CH₃), 4.29-4.34 (2H, q, CH₂), 7.17-7.18 (H, m, CH), 7.20-7.21 (H, m, CH), 9.49 (H, s, CH); ¹⁹F NMR (368 MHz, CDCl₃) δ ppm: −126.12-(−126.01) (2F, m, CF₂), −122.71-(−122.59) (2F, m, CF₂), −121.91-(−121.69) (4F, m, 2CF₂), −121.61-(−121.48) (2F, m, CF₂), −120.69-(−120.59) (2F, m, CF₂), −114.58-(−114.49) (2F, m, CF₂), −80.77-(−80.72) (3F, t, CF₃). ES-MS: ES+ m/z 111 C₂mim+, ES− m/z 499 C₈F₁₇SO₃—.

### Example 25: Full Name: Trihexyltetradecylphosphonium nonafluoro pentanoate

Abbreviation: [P_{6,6,6,14}][C₄F₉CO₂].

Synthetic Procedure: The commercially available starting material, [P_{6,6,6,14}][Cl] (3.87 g, 7.45 mmol) was dissolved in 40 ml of distilled water at room temperature and nonafluoropentanoic acid (1.94 g, 7.42 mmol) was added. The reaction mixture was stirred for 24 h under nitrogen gas. The white cloudy solution was extracted with DCM three times. The dichloromethane extract was washed with water five times followed by a single wash with potassium hydroxide (1 mM). DCM was removed in vacuo to afford a colourless liquid (4.91 g, 95%).

Characterisation—¹H NMR (400 MHz, CDCl₃) δ ppm: 0.85-0.93 (12H, t, 4CH₃), 1.25 (20H, m, 10CH₂), 1.27-1.35 (12H, m, 6CH₂), 1.39-1.55 (16H, m, 8CH₂), 2.12-2.24; ¹⁹F NMR (368 MHz, CDCl₃) δ ppm: −81.5 (3F, m, CF₃), −115.1 (2F, t, CF₂), −122.0 (2F, m, CF₂), −126.5 (2F, t, CF₂). ES-MS: ES+ m/z 483.5 P_{6,6,6,14}+, ES− m/z 263 C₅F₉O₂⁻, 219 C₅F₉⁻.

### Example 25A

Solubility: The solubility of [P_{6,6,6,14}][C₄P₉CO₂] in FPEE is Xα=>0.40.

Electrochemistry: The electrochemical method was the same as Example 5A except that the electrolyte was Xα 0.13 [P_{6,6,6,14}][C₄F₉CO₂]] in FPEE. The reference electrode was Ag/Ag triflate in [C₄mpyr][eFAP]. A constant potential of −2V vs the reference electrode was applied for two hours to determine the NH₃ formation rate. Two 1 mM H₂SO₄ traps were used to collect ammonia.

A yield rate of 2.14×10⁻¹² mol/cm²/s corresponding to a faradaic efficiency of 0.5%.

### Example 25B

Solubility: The solubility of [P_{6,6,6,14}][C₄P₉CO₂] in HFCP is Xα=>0.28.

Electrochemistry: The electrochemical method was the same as Example 5A except that the electrolyte was Xα 0.08 [P_{6,6,6,14}][C₄F₉CO₂] in HFCP. The reference electrode was Ag/Ag triflate in [C₄mpyr][eFAP]. A constant potential of −2V vs the reference electrode was applied for two hours to determine the NH₃ formation rate. Two 1 mM H₂SO₄ traps were used to collect ammonia.

A yield rate of 2.2×10⁻¹² mol/cm²/s was found corresponding to a faradaic efficiency of 1.5%.

### Example 26: Full Name: Trihexyltetradecylphosphonium tridecafluorohexane sulfonate

Abbreviation: [P_{6,6,6,14}][C₆P₁₃SO₃].

Synthetic Procedure: see procedure for [P_{6,6,6,14}][C₄P₉CO₂]. Potassium tridecafluorohexane sulfonate (3.04 g, 6.94 mmol) was added to [P_{6,6,6,14}][Cl] (3.59 g, 6.91 mmol), and water (40 mL), and after purification, afforded a colourless liquid (5.76 g, 96%).

Characterisation—¹H NMR (400 MHz, CDCl₃) δ ppm: 0.87-0.92 (12H, t, 4CH₃), 1.25 (20H, m, 10CH₂), 1.29-1.35 (12H, m, 6CH₂), 1.43-1.56 (16H, m, 8CH₂), 2.16-2.26; ¹⁹F NMR (368 MHz, CDCl₃) δ ppm: −81.3 (3F, t, CF₃), −114.9 (2F, t, CF₂), −121.1 (2F, m, CF₂) −122.3 (2F, m, CF₂), −123.3 (2F, m, CF₂), −126.6 (2F, m, CF₂). ES-MS: ES+ m/z 483.5 P_{6,6,6,14}+, ES− m/z 399 C₆F₁₃SO₃⁻.

### Example 26A

Solubility and Electrochemistry: Not tested, see Example 26B.

### Example 26B

Solubility: The solubility of [P_{6,6,6,14}][C₆F₁₃SO₃] in HFCP is Xα=>0.36.

Electrochemistry: The electrochemical method was the same as Example 5A except that the electrolyte was Xα 0.07 [P_{6,6,6,14}][C₆F₁₃SO₃] in HFCP. The reference electrode was Ag/Ag triflate in [C₄mpyr][eFAP]. A constant potential of −2V vs the reference electrode was applied for two hours to determine the NH₃ formation rate.

A yield rate of 2.5×10⁻¹² mol/cm²/s was found corresponding to a faradaic efficiency of 4.1%.

On the basis of this performance, the inventors anticipate a similar electrochemical result for Example 19A and 19B.

### Example 27: Full Name: Tributyl-(4,4,5,5,6,6,7,7,8,8,9,9,10,10,11,11,11-heptadecafluoroundecyl)-phosphonium nonafluorobutane sulfonate

Abbreviation: [P_{4,4,4},Rf][C₄F₉SO₃] where Rf═C₁₁H₆F₁₇.

Synthetic Procedure (Quaternisation): [P_{4,4,4},Rf][I] was synthesised similarly to literature methods (Tindale et al. Canadian Journal of Chemistry 2007, 85, 660+). Tributylphosphine (1.08 g, 5.34 mmol) was added to 4,4,5,5,6,6,7,7,8,8,9,9,10,10,11,11,11-Heptadecafluoroundecyl iodide (3.09 g, 5.25 mmol) and stirred under N₂ for 48 hours. Any residual starting material was removed in vacuo at 40° C. to afford a colourless liquid (4.15 g, 99%).

Characterisation: ¹H NMR (400 MHz, CDCl₃) δ ppm: 0.97-1.01 (9H, t, 3CH₃), 1.52-1.61 (12H, m, 6CH₂), 1.90-2.00 (2H, m, CH₂), 2.43-2.50 (8H, m, 4CH₂), 2.77-2.84 (2H, m, CH₂); ¹⁹F NMR (368 MHz, CDCl₃) δ ppm: [P_{4,4,4},Rf] −80.8 (3F, m, CF₃), −113.8 (2F, m, CF₂), −121.6 (2F, m, CF₂) −121.9 (4F, m, CF₂CF₂), −122.7 (2F, m, CF₂), −123.2 (2F, m, CF₂), −126.1 (2F, m, CF₂). ES− MS: ES+ m/z 663.1 P_{4,4,4},Rf+, ES− m/z 126.9 I—.

Synthetic procedure (Metathesis): [P_{4,4,4},Rf][I] (1.89 g, 2.39 mmol) was added to potassium nonafluorobutanesulfonate (0.84 g, 2.48 mmol), DCM (˜40 mL) and water (40 mL). After stirring under N₂ overnight, purification afforded a colourless liquid (1.93 g, 84%).

Characterisation: ¹H NMR (400 MHz, CDCl₃) δ ppm: 0.96-1.00 (9H, t, 3CH₃), 1.49-1.57 (12H, m, 6CH₂), 1.84-1.92 (2H, m, CH₂), 2.20-2.27 (8H, m, 4CH₂), 2.46-2.54 (2H, m, CH₂); ¹⁹F NMR (368 MHz, CDCl₃) δ ppm: [P_{4,4,4},Rf]-80.8 (3F, m, CF₃), −114.1 (2F, m, CF₂), −121.7 (2F, m, CF₂) −122.0 (4F, m, CF₂CF₂), −122.7 (2F, m, CF₂), −123.6 (2F, m, CF₂), −126.1 (2F, m, CF₂). [C₄F₉SO₃]— −81.1 (3F, t, CF₃), −114.7 (2F, t, CF₂), −121.7 (2F, m, CF₂) −126.1 (2F, m, CF₂) ES-MS: ES+ m/z 663.1 P_{4,4,4},Rf+, ES− m/z 299—C₄F₉SO₃

### Example 27A

Solubility: The solubility of [P_{4,4,4} C₁₁H₆F₁₇][C₄F₉SO₃] in FPEE is Xα=>0.64.

Electrochemistry: The electrochemical method was the same as Example 5A except that the electrolyte was Xα 0.10 [P_{4,4,4} C₁₁H₆F₁₇][C₄F₉SO₃] in FPEE. The reference electrode was Ag/Ag triflate in [C₄mpyr][eFAP]. To determine NH₃ formation rates a constant potential of −2V vs the reference electrode was applied for two hours to determine the NH₃ formation rate. Two 1 mM H₂SO₄ traps were used to collect ammonia.

A yield rate of 2.10×10⁻¹² mol/cm²/s was found corresponding to a faradaic efficiency of 5.3%.

On the basis of this performance, the inventors anticipate a similar electrochemical result for Examples 17A.

### Example 27B

Solubility and Electrochemistry: Not tested, see Example 27A.

### Example 28: Full Name: Tributyl-(4,4,5,5,6,6,7,7,8,8,9,9,10,10,11,11,11-heptadecafluoroundecyl)-phosphoniumtris(perfluoroethyl)trifluoro phosphate

Abbreviation: [P_{4,4,4},Rf][eFAP], Rf═C₁₁H₆F₁₇.

[P_{4,4,4},Rf][I] (1.88 g, 2.38 mmol) was added to 1-(2-Methoxyethyl)-1-methylpyrrolidinium tris(perfluoroethyl) trifluorophosphate (1.40 g, 2.38 mmol), DCM (˜40 mL) and water (40 mL). After stirring under N₂ overnight, purification afforded a colourless liquid (2.33 g, 88%).

Characterisation: ¹H NMR (400 MHz, CDCl₃) δ ppm: 0.96-0.99 (9H, t, 3CH₃), 1.47-1.54 (12H, m, 6CH₂), 1.74-1.87 (2H, m, CH₂), 2.02-2.09 (8H, m, 4CH₂), 2.20-2.31 (2H, m, CH₂); ¹⁹F NMR (368 MHz, CDCl₃) δ ppm: [P_{4,4,4,Rf}] −80.8 (3F, m, CF₃), −114.3 (2F, m, CF₂), −121.7 (2F, m, CF₂) −122.7 (4F, m, CF₂CF₂), −122.8 (2F, m, CF₂), −123.8 (2F, m, CF₂), −126.1 (2F, m, CF₂). [eFAP]− −43.4-(−45.8) (1F, m, PF), −80.3 (3F, m, C₂F₅), −81.9 (6F, m, 2CF₃), −89.2-(−86.8) (2F, m, 2PF), −115.4 (2F, m, CF₂), −115.9 (4F, m, 2CF₂). ES-MS: ES+ m/z 663.1 P 4,4,4,Rf+, ES− m/z 445-eFAP.

### Example 28A

Solubility: The solubility of [P_{4,4,4},C₁₁H₆F₁₇][eFAP] in FPEE is Xα=>0.65.

Electrochemistry: Not tested, see Example 17A and 27A.

### Example 28B

Solubility and Electrochemistry; Not tested see Example 17B and 27A.

### Example 29: Full Name: N-ethyl-N,N,N-tris(2-(2-methoxyethoxy)ethyl) ammonium tetrakis((1,1,1,3,3,3-hexafluoropropan-2-yl)oxy)borate

Abbreviation: [N_{2(2,O,2,O,1)3}][B(hfip)₄].

Synthetic procedure: The synthesis of starting material [Li(hfip)₄] was adapted from literature (Bulut et al., Dalton Transactions, 2011, 40, 8114). 11,1,1,3,3,3-hexafluoropropan-2-ol (16.40 g, 0.098 moles) was added dropwise to a solution of LiBH₄ (0.5 g, 0.023 moles) in 1,2-dimethoxyethane ((DME), 30 mL) at −15° C. under Nitrogen. The reaction was stirred at room temperature for 4 h followed by reflux (65° C.) for 12 h. The product was concentrated under high vacuum and further dried at 50° C. for 6 h to afford a white solid (13 g, 87%).

Characterisation: ¹H NMR (400 MHz, (d-THF) δ ppm: 4.70 (4H, m, CH). 11B NMR (128 MHz) (d-THF) ppm: δ1.80 (quin).

Synthesis (Quaternisation): The synthesis of [N₂₍₂₀₂₀₁₎₃][Br] was adapted from literature (Kar et al., Chem. Commun., 2016, 52, 4033, and Ferrero Vallana et al., 2017, New J Chem., 41(3), 1037-1045). Tris(2-(2-methoxyethoxy)ethyl)amine (10 g, 0.03 moles) and ethyl bromide (5.5 g, 0.05 moles) were mixed in acetonitrile (ACN) (50 mL) and stirred overnight at 50° C. under N₂ to give a yellow oil. The crude product was further purified through a column (20 g basic Al₂O₃, eluent: dichloromethane (DCM)). The solution was extracted with water (6×40 mL) and conc. in vacuo to give a pale yellow oil (9.2 g, 70%).

Characterisation: ¹H NMR (400 MHz, (d-CDCl₃) δ ppm: 3.99 (6H, m, (OCH₂)₃), 3.90 (6H, m, (OCH₂)₃), 3.74 (2H, q, NCH₂, J=7.12 Hz), 3.68 (m, 6H, (OCH₂)₃), 3.52 (6H, m, (NCH₂)₃), 3.35 (9H, s, (NCH₃)₃), 1.40 (3H, t, CH₃, J=7.06 Hz). ¹³C NMR (d-DMSO) δ ppm: 101.97, 71.36, 70.02, 64.33, 59.43, 58.65, 57.06, and 19.71. MS [ES]+=352.4 MS [ES] 79.9.

Synthesis (Metathesis): [Li(hfip)₄] (2.0 g, 0.003 moles) and [N₂₍₂₀₂₀₁₎₃][Br] (1.24 g, 0.0028 moles) were mixed in water and the solution was stirred for 12 h at room temperature. The crude product was extracted with DCM (5×25 mL) and concentrated in vacuo to give a pale yellow oil (1.70 g, 60%).

Characterisation: ¹H NMR (400 MHz, (d-DMSO) δ ppm: 7.78-7.76, (1H, d), 7.33-7.31 (1H, d), 4.70 (4H, m), 3.67-3.65 (2H, t), 3.58-3.56 (2H, t), 3.50-3.48 (4H, q),3.39 (3H, s), 2.4 (3H, s). 11B NMR (128 MHz) (d-DMSO) δ ppm: 1.50 (quin). MS [ES]+=352.4 MS [ES]=678.9 (small fragmentation peak observed at m/z 167).

### Example 29A

Solubility: Not tested, see Example 29B.

Electrochemistry: Not tested, see Example 29B.

### Example 29B

Solubility: The solubility of [N_{2(2,O,2,O,1)3}][B(hfip)₄] in HFCP is >2.4 mol/L.

Electrochemistry: The electrochemical method was the same as Example 5A except that the electrolyte was 3.7×10⁻¹ mol/L [N_{2(2,O,2,O,1)3}][B(hfip)₄] in HFCP. The reference electrode was a pseudo reference electrode of a Pt wire in the same electrolyte. A constant potential of −0.7V vs the reference electrode was applied for 2 hours to determine the NH₃ formation rate.

A rate of 1.09×10⁻¹¹ moles of NH₃/cm²/s was found corresponding to a faradaic efficiency of 15%.

On the basis of this performance, the inventors anticipate a similar electrochemical result for Example 29A.

### Example 30: Full Name: 1-butyl-1-methylpyrrolidinium tris(perfluoroethyl) trifluorophosphate

Abbreviation: [C₄mpyr][eFAP].

The compound was commercially available.

Solubility: [C₄mpyr][eFAP] was tested at X_{α} of 0.18 in HFCP and FPEE (1:1).

Electrochemistry: The electrochemical method was the same as Example 5A except that the electrolyte was X_{α} 0.18 [C₄mpyr][eFAP] in FPEE and HFCP (1:1). A constant potential of −2V vs the reference electrode was applied for two hours to determine the NH₃ formation rate. Two 1 mM H₂SO₄ traps were used to collect ammonia.

A yield rate of 3.3×10-12 mol/cm²/s was found corresponding to a faradaic efficiency of 4.7%.

### Example 31: Full Name: Trihexyl (4,4,5,5,6,6,7,7,8,8,9,9,10,10,11,11,11-heptadecafluoroundecyl)-ammonium nonafluorobutane sulfonate

Abbreviation: [N_{4,4,4},Rf][C₄F₉SO₃], Rf═C₁₁H₆F₁₇ also known as [N_{4,4,4},Rf][NfO], Rf═C₁₁H₆F₁₇.

[N_{4,4,4},Rf][I] was synthesised according to known literature methods (Alhanash et al, Journal of Fluorine Chemistry 2013, 156, 152-157.). 1,1,1,2,2,3,3,4,4,5,5,6,6,7,7,8,8-heptadecafluoro-11-iodoundecane (2.49 g, 4.23 mmol) was added to tributylamine (0.78 g, 4.23 mmol) and acetonitrile (30 mL), and after purification, afforded a white solid (1.43 g, 43%).

Synthetic Procedure: see procedure for [P_{6,6,6,14}][C₅F₉O₂]. [N_{4,4,4},Rf][I] (1.17 g, 1.51 mmol) was added to potassium nonafluorobutanesulfonate (0.53 g, 1.57 mmol) and water (40 mL) at 60° C., and after purification, afforded a white solid (1.00 g, 70%).

Characterisation—¹H NMR (400 MHz, CDCl₃) δ ppm: 0.96-1.05 (9H, t, 3CH₃), 1.39-1.48 (6H, m, 3CH₂), 1.29-1.35 (12H, m, 6CH₂), 1.62-1.73 (6H, m, 3CH₂), 1.97-2.08 (2H, p, CH₂), 2.25-2.40 (2H, (triplet of)t, CH₂), 3.19-3.30 (6H, m, CH₂), 3.46-3.54 (2H, m, CH₂); ¹⁹F NMR (368 MHz, CDCl₃) δ ppm: [N_{4,4,4},Rf]+−81.1 (3F, t, CF₃), −113.6 (2F, t, CF₂), −121.7 (2F, m, CF₂) −121.9 (4F, m, CF₂CF₂), −122.7 (2F, m, CF₂), −123.4 (2F, m, CF₂), −126.1 (2F, m, CF₂). [C₄F₉SO₃⁻]— −80.8 (3F, t, CF₃), −114.7 (2F, m, CF₂), −121.7 (2F, m, CF₂), −126.1 (2F, m, CF₂) ES-MS: ES+ m/z 646 N_{4,4,4},Rf+, ES− m/z 299 C₄F₉SO₃⁻

### Example 32: Full Name: N-ethyl-N,N,N-tris(2-(2-methoxyethoxy) ethyl)ammonium tris(perfluoroethyl) trifluorophosphate

Abbreviation: [N_{2(2,O,2,O,1)3}][eFAP].

Synthesis (Quaternisation): see procedure for [N_{2(2,O,2,O,1)3}][Br].

Synthesis (Metathesis): 1-(2-methoxyethyl)-1-methylpyrrolidinium [eFAP] (6.8 g, 0.012 moles) and [N₂₍₂₀₂₀₁₎₃][Br] (5 g, 0.012 moles) were mixed in dichloromethane (DCM) and the solution was stirred for 12 h at room temperature. The crude product was washed with water (3×30 mL) and concentrated in vacuo to give a colourless oil (8.2 g, 89%).

Characterisation: ¹H NMR (400 MHz, (d-CDCl₃) δ ppm: 3.82-3.85 (6H, m), 4.70 (4H, m), 3.61-3.56 (14H, m), 3.50-3.48 (6H, q), 3.34 (9H, s), 1.33 (3H, t); ¹⁹F NMR (368 MHz, (CDCl₃) δ ppm: [eFAP]− −115.5 (4F, m, 2CF₂), −116.6 (2F, m, CF₂), −89.6-(−87.1) (2F, m, 2PF), −81.8 (6F, m, 2CF₃), −80.3 (3F, m, C₂F₅), −43.8-(−46.3) (1F, m, PF). MS [ES]+=352.3 MS [ES]=444.9.

### Example 32A

Solubility: [N_{2(2,O,2,O,1)3}][eFAP] is miscible with FPEE in all proportions.

Electrochemistry: Not tested, see Example 32B.

### Example 32B

Solubility: [N_{2(2,O,2,O,1)3}][eFAP] is miscible with HFCP in all proportions.

Electrochemistry: The electrochemical method was the same as Example 5A except that the electrolyte was 0.1 mol/L [N_{2(2,O,2,O,1)3}][eFAP] in HFCP. The reference electrode was Ag/Ag⁺ in [C₄mpyr][eFAP]. A constant potential of −0.6V vs the reference electrode was applied for two hours to determine the NH₃ formation rate.

On the basis of this performance, the inventors anticipate a similar electrochemical result for Example 32A.

### Mixtures

### Example 33: Full Name: Trihexyltetradecylphosphonium tris(perfluoroethyl) trifluorophosphate and Trihexyltetradecylphosphonium heptadecafluorooctanesulfonate

Abbreviation: [P_{6,6,6,14}][eFAP]+[P_{6,6,6,14}][C₈F₁₇SO₃].

Synthetic procedure (metathesis [P_{6,6,6,14}][eFAP]): See procedure for [P_{6,6,6,14}][C₄F₉CO₂]. [P_{6,6,6,14}][Cl] (7.39 g, 14.2 mmol) was added to [C₄mpyr][eFAP] (8.59 g. 14.6 mmol) and water (˜90 mL). After extraction, DCM was removed in vacuo to afford a colourless viscous oil (11.7 g, 88%).

Characterisation: ¹H NMR (400 MHz, DMSO) δ ppm: 0.84-0.88 (12H, t, 4CH₃), 1.23 (20H, m, 10CH₂), 1.25-1.29 (12H, m, 6CH₂), 1.33-1.40 (8H, m, 4CH₂), 1.42-1.50 (8H, m, 4CH₂), 2.10-2.18 (8H, m, 4CH₂); ¹⁹F NMR (400 MHz, DMSO) δ ppm: 116.27 (115.76) (4F, m, 2CF₂), 115.67 (115.26) (2F, m, CF₂), −88.71-(−86.10) (2F, dm, 2PF), −81.13-(−81.02) (6F, m, 2CF₃), −79.61-(−79.40) (3F, m, C₂F₅), −45.50-(−42.86) (1F, m, PF). ES-MS: ES+ m/z 483 P_{6,6,6,14}+, ES− m/z 445 eFAP−.

Synthetic procedure (metathesis [P_{6,6,6,14}][C₈F₁₇SO₃]): See procedure for [P_{6,6,6,14}][C₄F₉CO₂]. [P_{6,6,6,14}][Cl] (2.32 g, 4.47 mmol) was added to potassium heptadecafluorooctanesulfonate (2.34 g, 4.35 mmol) and water (40 mL). After extraction, DCM was removed in vacuo to afford a colourless oil (4.33 g, 99%).

Characterisation: ¹H NMR (400 MHz, DMSO) δ ppm: 0.84-0.88 (12H, t, 4CH₃), 1.23 (20H, m, 10CH₂), 1.35-1.39 (12H, m, 6CH₂), 1.42-1.46 (8H, m, 4CH₂), 2.11-2.18 (8H, m, 4CH₂), 3.72-3.85, (8H, m, 4CH₂); ¹⁹F NMR (400 MHz, DMSO) δ ppm: 80.42 (80.37) (3F, m, CF₃), −114.83-(−114.76) (2F, t, CF₂), −121.39-(−121.31) (2F, m, CF₂), −125.68-(−125.57) (2F, t, CF₂). ES− MS: ES+ m/z 483 P 6,6,6,14+, ES− m/z 499 [C₈F₁₇SO₃]—.

### Example 33A

Solubility & Electrochemistry: The electrochemical method was the same as Example 5A except that the electrolyte was X_{α} 0.07 [P_{6,6,6,14}][eFAP] and X_{α} 0.08 [P 6,6,6,14][C₈F₁₇SO₃] in FPEE. The reference electrode was Ag/Ag triflate in [C₄mpyr][eFAP]. A constant potential of −2V vs the reference electrode was applied for two hours to determine the NH₃ formation rate. Two 1 mM H₂SO₄ traps were used to collect ammonia.

A yield rate of 3.4×10⁻¹² mol/cm₂/s was found corresponding to a faradaic efficiency of 5.4%.

On the basis of this performance, the inventors anticipate a similar electrochemical result for Example 33B.

### Example 33B

Solubility and Electrochemistry: Not tested, see Example 33A.

### Example 34 Studies of Faradaic Efficiency

The following further example illustrate enhanced faradaic efficiency and yield rate of ammonia in NRR carried out in ambient conditions. Surface area enhanced α-Fe@Fe₃O₄ nanorods grown on carbon fibre paper (CFP) were used as a NRR catalyst in an aprotic perfluorinated solvent-liquid salt mixture.

At room temperature and pressure, a moderate ammonia yield rate of 2.35×10⁻¹¹ mol s⁻¹ cm⁻² with a high Faradaic efficiency of 32% was achieved in a XIL=0.23 electrolyte mixture of liquid salt/perfluorinated solvent (1-butyl-1-methy pyrrolidinium tris(pentafluoroethyl)trifluorophosphate/1H,1H,5H-octafluoropentyl 1H,1H,5H-octafluoro pentyl 1,1,2,2-tetrafluoroethyl ether). This study reveals that the ability to limit the availability of proton while increasing the N₂ solubility from using aprotic fluorinated electrolyte media could effectively suppress HER. Therefore, the use of fluorinated solvent could be essential in furthering the development of electrochemical NRR technology.

The aforesaid further experiments were performed in respect of the ionic salt/solvent electrolyte combinations set out in Table 2.

Materials: 1-butyl-1-methy pyrrolidinium tris(pentafluoroethyl) trifluorophosphate ([C₄mpyr][eFAP]) was purchased from Merck. Hydrofluoroether, 1H,1H,5H-Octafluoropentyl 1H,1H,5H-Octafluoropentyl 1,1,2,2-tetrafluoroethyl ether (FPEE) was purchased from Synquest. Anhydrous Iron(III)chloride was purchased from Sigma-Aldrich. Sodium sulfate was purchased from Ajax finechem. Carbon fibre paper (CFP) was purchased from Fuel Cell Store.

The gases (Argon and N₂) were supplied by Air Liquide. Ultra-high purity grade Alphagaz™ (H₂O<3 ppm; O₂<2 ppm; CₙHₘ<0.5 ppm) N₂ and Ar were used in all experiments.

Iron nanorod synthesis: Prior to the modification of CFP with Fe@Fe3O4 NR, CFP was treated overnight with a piranha solution (3:1 v/v, H₂SO₄:10% H₂O₂) to introduce oxygen functional groups important for metal nucleation. In a glass beaker, 0.95 g of the anhydrous FeCl₃ was dissolved in 70 ml of 0.5 M Na₂SO₄ using a magnetic stirrer for 5 minutes. The solution was transferred into a Teflon lined autoclave containing 3 cm×2 cm of the piranha treated CFP. The autoclave was sealed and kept at 160° C. for 6 hours. Following the hydrothermal reaction, a yellow film was formed (β-FeOOH) on the surface of the CFP. The film was rinsed thoroughly with Milli-Q water and ethanol and dried overnight in a vacuum oven at 60° C.

To synthesize the α-Fe@Fe3O4, the β-FeOOH on CFP was annealed at 300° C. for 2 hours achieved with a ramping rate of 5° C. min′ under a constant H₂ flow of 5 ml min⁻¹. Following the annealing, the initially yellow film was transformed into a black film and exhibited a strong ferromagnetism. The loading of the α-Fe@Fe3O4 NR on CFP was determined to be 0.5 mg cm⁻².

Electrode preparation: To prepare the electrode, the CFP modified with α-Fe@Fe3O4 nanorods were cut into pieces with size of 0.5 cm×0.5 cm. The unused portion of the CFP was then sealed with Cu tape and soldered to a Cu wire. All of the Cu portions were electrochemically passivated.

Electrochemical cell: Three electrodes electrochemical cell composed of working electrode (W.E., CFP@Fe NR), reference electrode (R.E.) and counter electrode (C.E., Pt wire) was used. To prepare the R.E., silver trifluoromethanesulfonate was dissolved in [C₄mpyr][eFAP] to form 10 mM Ag⁺ electrolyte. The reference electrode was calibrated against normal hydrogen electrode (NHE) with ferrocene/ferrocenium couple (Fc/Fc⁺) in X_{IL}, =0.23 electrolyte mixture, with a basis of E⁰(Fc/Fc+)=0.64 V vs NHE. The C.E. used in this experiment was separated using a glass fritted anode chamber filled with the corresponding electrolyte.

Gas purification and treatment and NRR set-up: Gases used in this study (unless specifically mentioned) is further purified from NOₓ, O₂ and H₂O by passing the gas through a 10 mM H₂SO₄ Milli-Q trap, O₂ trap column (Agilent) and a H₂O trap column (Agilent), respectively. For wet N₂ gas, the columns were not used.

The flow of the wet and dry N₂ gas were regulated with separate gas flow meter. Before entering the electrochemical cell, the gases were mixed in a mixing chamber. The reacted N₂ was then passed through a final 3 ml, 1 mM H₂SO₄ ammonia trap to capture the as-formed ammonia during the NRR.

Ammonia detection with indophenol blue method: Ammonia was extracted from the reaction vessel containing the hydrophobic electrolyte mixture using 1 ml of Milli-Q washing solution. From the wash solution, 0.5 ml of Milli-Q was taken and transferred into a 1 ml sample tube. Into the tube 0.5 ml of 0.5 M NaClO₄, 50 μL of 1M NaOH solution (with 5 wt. % salicylic acid and 5 wt. % sodium citrate) and 10 μL of 0.5 wt. % C₅FeN₆Na₂O (sodium nitroferricyanide) in water. The mixture was then incubated in the dark at room temperature for 3 hours before the UV-vis test.

The concentration of ammonia is determined by a calibration plot. The calibration plot was prepared by dissolving a known amount of NH₄Cl in Milli-Q water. Subsequently the solutions were reacted with the indophenol blue method reagents and the ammonia content was determined using UV-Vis. The calibration plot was collected at least three times to determine the measurement errors. Calibration plot for the 1 mM H₂SO₄ traps were also collected separately according to the described method.

### Physical Characterisation

Carbon fibre paper (CFP) was selected as an electrode substrate to grow Fe nanorods (NR) due to its electrochemical inertness of conductive carbon substrate and high porosity to provide enhanced active surface area. Prior to the surface functionalisation, CFP was treated with piranha solution (a mixture of sulphuric acid and hydrogen peroxide) to create surface-bound oxygen functionalities, important for the initial heteronucleation step of the metal cations. In typical synthesis, 0.95 g of anhydrous FeCl₃ is dissolved in 70 ml of 0.5 M Na₂SO₄. The mixture was transferred into a 100 ml Teflon-lined autoclave and hydrothermally treated at 160° C. for 6 hours. Following, hydrothermal reaction, a uniform layer of bright-yellow β-FeOOH coating was formed, confirmed by X-ray diffraction (XRD) analysis.

Thermal annealing under Hz-atmosphere was employed to reduce the as-synthesised β-FeOOH. The successful synthesis of α-Fe@Fe3O4 NR was validated by both X-ray diffraction (XRD) and scanning electron microscopy characterization techniques. XRD reveals the presence of an intense α-Fe peak at 44.8°, arising from the (110) crystal plane from an α-Fe body centred cubic system with Im-3m space group (JCPDS 06-0696). (Vayssieres et al., Nano letters, 2001, 2, 1393-1395). Relatively weaker peaks observed at 30.0°,33.8° and 43.7° corresponds to (220), (311) and (400) crystal planes in Fe₃O₄. The presence of Fe₃O₄ can be attributed to the formation of passivating oxides layer from atmospheric exposure of Fe to oxygen. (Konishi et al., Materials Transactions, 2005, 46, 329-336).

As a proof of concept and based on precedent reports, Fe-based NRR catalyst was used. The Fe catalyst was directly grown on carbon fibre paper (CFP) substrate through hydrothermal method to achieve a high surface area array of nanorods. The electrolyte used in this study is composed of a fluorinated ionic liquid (1-butyl-1-methypyrrolidinium tris(pentafluoroethyl)trifluorophosphate; ([C₄mpyr][eFAP])) and a hydrofluoroether (1H,1H,5H-octafluoropentyl 1H,1H,5H-octafluoropentyl 1,1,2,2-tetrafluoroethyl ether; (FPEE)). Both compounds have been shown to exhibit significantly enhanced N₂ solubility at RTP. In a previous study employing [C₄mpyr][eFAP] as electrolyte on planar Fe-cathode deposited on FTO, a high FE of 60% and ammonia yield rate of 4.7×10⁻¹² mol s⁻¹ cm⁻². In this study, the use of FPEE is expected to increase the subsequent adsorption to the electrode active sites.

Scanning electron microscopy (SEM) reveals the morphology and direction of growth of the synthesized β-FeOOH and α-Fe@Fe3O4 nanorods. The β-FeOOH grows in a perpendicular direction against the carbon fiber substrate forming a dense array of Fe nanorods. The β-FeOOH exhibits average diameter of 100-150 nm and length of ˜500-1000 nm. Following, the thermal annealing in H₂, the overall morphology of the array is maintained. Most noticeably, the diameter of the individual nanorods is significantly reduced to ˜40-60 nm. The initially tubular nanorods transformed into morphology that resembles interconnected spherical particles. The significant reduction of the nanorod diameter validated the reduction of the β-FeOOH to α-Fe from the removal of structural oxygen from the crystal structure. This efficient reduction by H₂ was also assisted by the existence of direct crystallographic transformation pathway between β-FeOOH and α-Fe.

### Electrochemical Characterisation

The electrochemical studies were conducted using a standard 3-electrodes in a cell set-up as illustrated in FIG. 3. The electrochemical cell was sealed to prevent gas leakages. To prevent the re-oxidation of the produced ammonia, Pt-wire counter electrode was isolated using glass frit compartment. Nitrogen gas and H₂O were supplied into the cell with a teflon tubing which positioned close to the cathodic working electrode, the reacted gas then flown into 5 ml acid trap (1 mM H₂SO₄) to capture the produced ammonia.

The physicochemical and electrochemical properties of FPEE, [C₄mpyr][eFAP], (FIG. 4) and their mixtures were initially characterised to help determining the optimum solvent-IL ratio for electrochemical measurements. One of the issue in the use of IL as electrolyte is their generally high viscosity, which leads to the significantly smaller diffusion coefficient of any redox species by more than two order of magnitudes compared to conventional solvents as well as ionic mobility. (Lewandowski, Journal of Solution Chem, 2013 42, 251-262; Wu et al., Electrochimica Acta, 211 56, 3209-3218) Therefore the use of low-viscosity solvent is important in improving the diffusion coefficient, improving the mass transport of redox species and conductance.

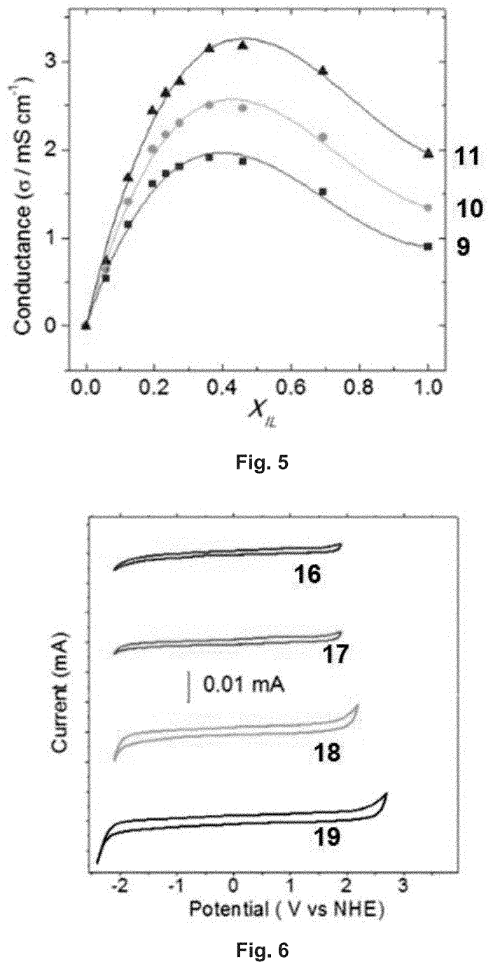

As displayed by the plots of conductance vs. IL mole fraction (X_{IL}) in FPEE in FIG. 5, the use of FPEE as solvent with 0.09>X_{IL}>1.00 improves the conductivity of [C₄mpyr][eFAP] of 0.88 mS cm⁻¹. A maximum conductivity of 1.95 mS cm⁻¹ is achieved with X_{IL} of 0.4. The increase in the conductance could be ascribed to the increased ionic mobility due to the lowered viscosity or increase in temperature, as described by the Stokes-Einstein relation. However, with the increasing amount of solvent, the role of ions concentration will eventually become more critical resulting in the drop of conductance as seen at X_{IL}<0.09 in FIG. 5. (Bonhote et al., Inorganic chemistry, 1996, 35, 1168-1178).

As previously reported, although most ionic liquid exhibit large electrochemical windows, the introduction of solvent could alter the electrochemical windows of the ionic liquids. (Buzzeo et al., ChemPhysChem, 2006, 7, 176-180) The cyclic voltammograms (CVs) in FIG. 6 show the effect of FPEE addition to the anodic and cathodic limits of [C₄mpyr][eFAP]. The voltammograms were collected on a glassy carbon disk electrode under continuous Ar-purging. The CVs were collected on a glassy carbon disk electrode under continuous Ar-purging. As shown in FIG. 6, the mixtures exhibit cathodic limit of at least −1.90 V vs NHE and an anodic limit beyond 1.50 V, still greatly exceeds the previously reported optimum NRR potential on electrodeposited Fe electrode of −0.80 V vs. NHE. (Zhou et al., Energy & Environ. Sci., 2017, DOI: 10.1039/C7EE02716H). Hence, the results have indicated the suitability of using FPEE as an electrolyte system for NRR.

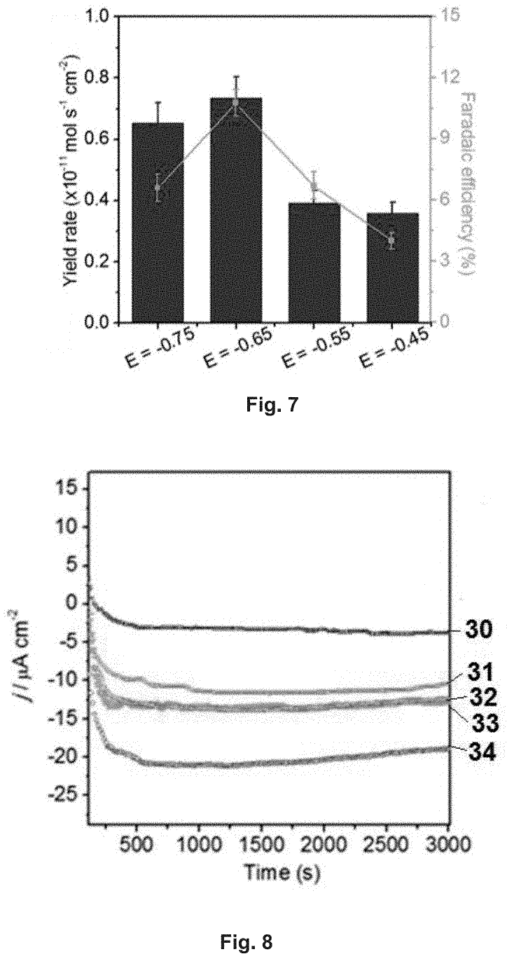

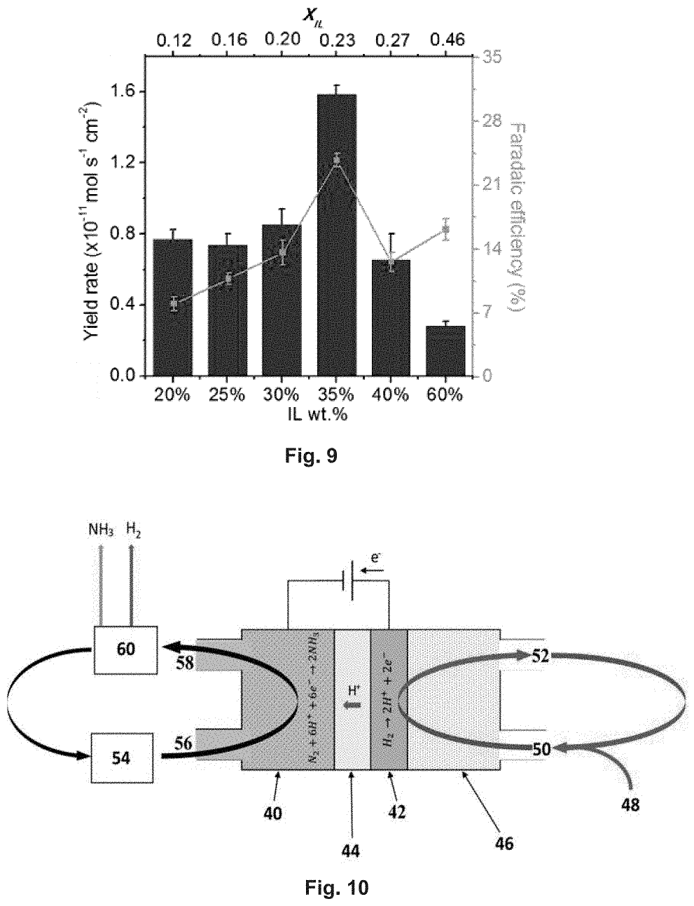

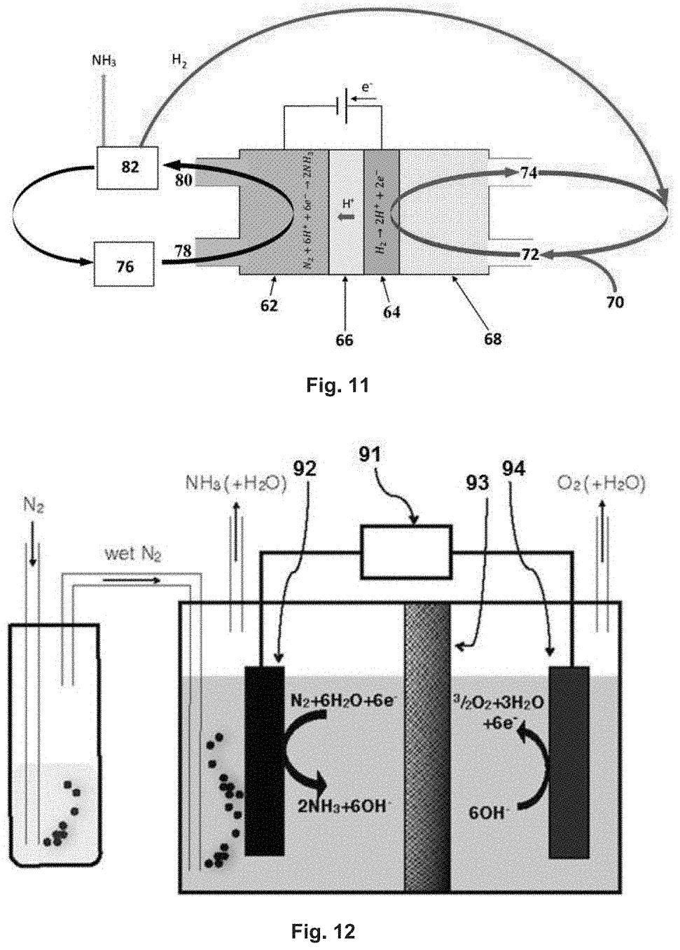

Further investigation of the NRR were carried out with controlled potential electrolysis (CPE) technique in X_{IL}=0.16. Nitrogen gas feedstock with controlled amount of moisture (CH₂O=˜100 ppm) was used as proton source for the formation of NH₃. Prior to CPE experiments, the α-Fe@Fe3O4 NR cathodes were subjected to electrochemical activation at −1.35 V vs NHE for 60 s. During this period, NH₃ yield rate is ˜8.0×10⁻¹² mol s⁻¹ cm⁻²¹, which corresponds to a NH₃ total yield of ˜0.2 nmol, which is significantly lower value than the average yield reported herein (10-30 nmols). CPE with different applied potentials ranging from −0.45 V to −0.75 V vs NHE were carried out and the current transients are shown in FIG. 7.

The highest FE and NH₃ yield rate of 11.0±0.6% and 7.4×10⁻¹² mol s⁻¹ cm⁻² mg m⁻² h⁻¹, respectively, were achieved at an applied potential of −0.65 V. This potential is lower than the previously reported optimum NRR potential of −0.8 V vs NHE on electrodeposited Fe cathode in pure [C₄mpyr][eFAP]. The application of more negative potential of −0.75 V resulted in diminished FE and ammonia yield rate of 6.6±0.7% and 6.5×10⁻¹² mol s⁻¹ cm⁻². The decreases could be ascribed to the increased selectivity towards proton reduction/hydrogen evolution reaction (HER) at more negative potentials. (Zhou et al., Energy & Environ. Sci., 2017, DOI:10.1039/C7EE02716H; Singh et al. ACS Catalysis, 2017, 7, 706-709).

In contrast to recent reports, (Chen et al., Angew. Chem. Int. Ed., 2017, 56(10), 2699-2703; Kong et al., ACS Sus. Chem. Eng., 2017, 5(11), 10986-10955) both experimental and theoretical investigations have indicated that at RTP, Fe₂O₃ is not the catalytically active centre for NRR in this electrolyte system, rather it is the metallic/reduced Fe-species.

Accordingly, a control Fe₂O₃ cathode was tried. The Fe₂O₃ was validated by XRD characterizations, showing that the peak at 2θ=45° for α-Fe (110) has disappeared. Although at the optimised potential of −0.65 V Fe₂O₃ NR cathode exhibits higher cathodic j, the NRR activity was significantly lower. The ammonia was formed with FE of <1.00% and a yield rate of less than 4.75×10⁻¹² mol s⁻¹ cm⁻².

Although a number of Fe₂O₃ based catalysts have been previously reported for electrochemical NRR, high FE and NH₃ have only been typically reported for elevated temperature and operated in reductive H₂ environment. (Licht et al., Science, 2014, 345, 637-640; Cui et al., Green chemistry, 2017, 19, 298-304). Therefore, there is a strong indication that Fe₂O₃ does not provide catalytically active centres for NRR, but rather the active centres are associated with metallic/reduced Fe species.

As an example, Chen et al. has reported the use of Fe₂O₃/carbon nanotube hybrid cathode for NRR at RTP in aqueous media. They reported a maximum FE of 0.15% and a maximum NH₃ yield rate of 3.6×10⁻¹² mol s⁻¹ cm⁻². (Chen et al., Angewandte Chemie International Ed., 2017, 56, 2699-2701). Therefore, it is shown that the core-shell α-Fe@Fe₃O₄ NR structure is important for NRR. The Fe₃O₄ shell provides a protection to the metallic α-Fe core against further oxidation. Additionally, in contrast to the bulk reduction of Fe₃O₄ particles, the combination of a highly conductive α-Fe core and Fe₃O₄ shell should theoretically lower the energy cost for its reduction.

Furthermore, in recognising the role of liquid salt mole fraction on the physicochemical properties of the electrolyte mixture, the NRR performance of the system is further optimised for X_{IL} FIG. 8 shows the typical current density (j) obtained in a range of different X_{IL}. At a low X_{IL} of 0.12 an average current density of ˜11 μA cm⁻², while the lowest current density of ˜3.5 μA cm⁻² exhibited at X_{IL} of 0.46. The highest current density of ˜20 μA cm⁻² was achieved at X_{IL}, of 0.23. The variation could be dictated by several factors such as viscosity, conductivity and N₂ solubility. In this case, the highest FE of 23.8±0.8% with a NH₃ yield rate of 1.58×10⁻¹¹ mol s⁻¹ cm⁻² was achieved at X_{IL}=0.23. The highest XL tested in this series was 0.46, exhibited FE of 16.2±1.2% and NH₃ yield rate of 2.7×10⁻¹² mol s⁻¹ cm⁻² mg m⁻² h⁻¹.

The significant drop of NH₃ yield rate signifies the important role of FPEE in dissolving a high amount of N₂. This observation was further confirmed by the NRR performance at lowest X_{IL} of 0.12 tested in the series. At lower liquid salt mole fraction, the conductance is shown to decrease, leading to a lowered FE by a factor of 2, however the NH₃ yield rate remains significantly higher than that in X_{IL} of 0.46, indicating a definitive role of FPEE in increasing the ammonia yield rate. However, the factors correlating FE to X_{IL} are harder to define.

These observations indicate that for each salt/solvent combination there is an optimum yield rate composition that combines high nitrogen solubility as well as high conductivity in the electrolyte as well as low viscosity.

Based on a previous study, it has been shown that in a pure IL system a significantly higher FE of 60% is achievable. (Zhou et al, Energy & Environ. Sci., 2017, DOI: 10.1039/C7EE02716H). The possible explanation to this is the presence of complex molecular interaction and/or different diffusion behaviour of neutral N₂ molecule and polar H₂O with the mixed electrolyte system. (Araque et al., The Journal of Physical Chemistry B, 2015, 119, 7015-7029). Therefore, as proposed by a precedent viewpoint by Singh et al., (ACS Catalysis, 2017, 7, 706-709), this study has proven the ability of aprotic solvents in enhancing the NRR efficiency by limiting the availability of protons in the electrochemical system. In addition, the use of FPEE further supports NRR, due to the lowered viscosity and significantly enhanced N₂ solubility, which could dramatically increase N₂ mass transport towards the cathode.

Notwithstanding, protons are also an important element for NH₃ synthesis, further investigation on the role of moisture concentration in the optimised system of X_{IL}=0.23 was carried out. By altering the C_{H2O} amount in the system, FE as high as 32% and NH₃ yield rate of 2.35×10⁻¹¹ mol s⁻¹ cm⁻² could be achieved. The reported FE is the highest reported in aprotic solvent/liquid salt system, as well as compared to the previously reported NRR catalyst for aqueous solution to date (Table 3).

TABLE 3
List of previously reported FE and Yield of NRR catalyst at ambient temperature
and pressure. (*Ag/AgCl was converted to NHE on the basis of E(Ag/AgCl) =
0.197 vs NHE; SCE was converted to NHE on the basis of E(SCE) = 0.240 vs NHE):

| | | | Yield rate | FE | Potential | | | Year | |
|---|---|---|---|---|---|---|---|---|---|
| Cathode | Electrolyte | Anode | mol cm⁻² s⁻¹ | (%) | (vs NHE)* | | T | (Ref) | |
| Fe electrode | 6N KOH | St. Steel | 0.6 × 10⁻¹⁴ | Not | −0.85 | V | 25 | 1983 | (1) |
| | | | | reported | | | | | |
| Ru/C | Nation | Pt | 3.43 × 10⁻¹² | 0.28% | −0.9 | V | 25 | 2000 | (2) |
| Pt/Ppy | Li⁺/H⁺ | Pt/C | 3.61 × 10⁻¹¹ | <0.1% | −0.165 | V | 25/60 bar | 2010 | (3) |
| (polypyrolle) | | | | | | | | | |
| Pt/C | Nation | Pt | 1.14 × 10⁻⁹ | 0.55% | 0.2 V vs | | 25 | 2013 | (4) |
| | | | | | RHE | | | | |
| Porous Ni | H₂SO₄/2-Propanol | Pt | 1.75 × 10⁻¹¹ | 0.90% | 3.5 V bias | | 25 | 2016 | (5) |
| Fe/CNT | Nafion/GDL | Pt | 3.59 × 10⁻¹² | 0.03% | −1.80 | V | 25 | 2016 | (6) |
| Au NR | 0.1M KOH/Nafion | Pt | 2.69 × 10⁻¹¹ | 4.00% | −0.97 | V | 25 | 2016 | (7) |
| Au/TiO₂ | HCl/Nafion | Pt | 5.94 × 10⁻⁹ | 8.11% | −0.2 V vs | | 25 | 2017 | (8) |
| | | | | | RHE | | | | |
| Au—CeOx/RGO | HCl/Nafion | Pt | 1.35 × 10⁻¹⁰ | 10.10% | −0.2 V vs | | 25 | 2017 | (9) |
| | | | | | RHE | | | | |
| Polyimide/C | Li⁺/H⁺ | Pt | 7.68 × 10⁻¹² | 2.91% | −0.4 V vs | | 25 | 2017 | (10) |
| | | | | | RHE | | | | |
| Fe electrode/ | [C₄mpyr][eFAP] | Pt | 4.7 × 10⁻¹² | 60.00% | −0.8 | V | 25 | 2017 | (11) |
| FTO | | | | | | | | | |

| | | | | | | | | |
|---|---|---|---|---|---|---|---|---|
| Mo Nanofilm | 0.01M H₂SO₄ | Pt | 3.09 × 10⁻¹¹ | 0.72% | −0.49 V vs | 25 | 2017 | (12) |
| | | | | | RHE | | | |
| γ-Fe₂O₃ | 0.1M KOH | Pt | 1.20 × 10⁻¹¹ | 2.0% | 0.0 V vs | 25 | 2017 | (13) |
| | | | | | RHE | | | |

| | | | | | | | | |
|---|---|---|---|---|---|---|---|---|
| α-Fe@Fe₃O₄ | [C₄mpyr][eFAP] - | Pt | 2.35 × 10⁻¹¹ | 32.0% | −0.6 | V | 25 | This |
| | FPEE mix | | | | | | | invention |

### REFERENCES FOR TABLE 3

1. A. Sclafani, V. Augugliaro and M. Schiavello, Journal of the Electrochemical Society, 1983, 130, 734-736.
2. V. Kordali, G. Kyriacou and C. Lambrou, Chemical Communications, 2000, DOI: 10.1039/B004885M, 1673-1674.
3. F. Köleli and D. B. Kayan, Journal of Electroanalytical Chemistry, 2010, 638, 119-122.
4. R. Lan, J. T. S. Irvine and S. Tao, Scientific Reports, 2013, 3, 1145.
5. K. Kim, N. Lee, C.-Y. Yoo, J.-N. Kim, H. C. Yoon and J.-I. Han, Journal of the Electrochemical Society, 2016, 163, F610-F612.
6. S. Chen, S. Perathoner, C. Ampelli, C. Mebrahtu, D. Su and G. Centi, Angewandte Chemie International Edition, 2017, 56, 2699-2703.
7. D. Bao, Q. Zhang, F.-L. Meng, H.-X. Zhong, M.-M. Shi, Y. Zhang, J.-M. Yan, Q. Jiang and X.-B. Zhang, Advanced Materials, 2017, 29, 1604799-n/a.
8. M.-M. Shi, D. Bao, B.-R. Wulan, Y.-H. Li, Y.-F. Zhang, J.-M. Yan and Q. Jiang, Advanced Materials, 2017, 29, 1606550-n/a.
9. S.-J. Li, D. Bao, M.-M. Shi, B.-R. Wulan, J.-M. Yan and Q. Jiang, Advanced Materials, DOI: 10.1002/adma.201700001, n/a-n/a.
10. G.-F. Chen, X. Cao, S. Wu, X. Zeng, L.-X. Ding, M. Zhu and H. Wang, Journal of the American Chemical Society, 2017, DOI: 10.1021/jacs.7b04393.
11. M. Ali, F. Zhou, K. Chen, C. Kotzur, C. Xiao, L. Bourgeois, X. Zhang and D. R. MacFarlane, Nature Communications, 2016, 7, 11335.
12. D. Yang, T. Chen and Z. Wang, Journal of Materials Chemistry A, 2017, 5, 18967-18971.
13. J. Kong, A. Lim, C. Yoon, J. H. Jang, H. C. Ham, J. Han, S. Nam, D. Kim, Y.-E. Sung, J. Choi and H. S. Park, ACS Sustainable Chemistry & Engineering, 2017, 5, 10986-10995.

Finally, time dependent NRR studies were also carried out. The amount of NH₃ produced was found to continuously increase as the electrolysis period was increased. This result provides unambiguous evidence of the formation of NH₃ from NRR.

In summary, it is clear that metallic Fe sites are the electrocatalytically active NRR centres under ambient conditions. It is shown that a significantly enhanced NRR FE of 32% has been achieved under ambient conditions by choosing the appropriate electrolyte-catalyst system. The ability to control the amount of proton supply in an aprotic solvent is shown to greatly enhance the FE and NH₃ yield rate at RTP due to the improved selectivity for NRR over HER. In addition, it is shown that the ability of fluorination to solubilise larger amount of N₂ while reducing the viscosity of liquid salts is key to achieving systems with high NRR activity.

From a catalyst design point of view, with a core-shell structure of α-Fe@Fe₃O₄ NR, the loss of energy in the initial reduction of the Fe₃O₄ passivating shell could be minimized.

### Liquid Flow Cell

### Example 34

This example relates to the use of one embodiment of the invention in which a flowing liquid electrolyte is used. Preferably, the liquid flow cell for N₂ reduction to ammonia consists of two electrodes, a cathode and an anode which are separated by a polymer membrane as depicted in FIG. 10.

The cathode (the working electrode on which N₂ reduction takes place) is preferably a porous, conductive, three-dimensionally structured substrate, which is coated with a high surface area, N₂ reduction catalyst. Electrolyte, saturated with dissolved N₂ by bubbling, is pumped from the bubbler and through the cathode. As it passes through the cathode, the electrolyte delivers N₂ to the catalyst where it is adsorbed and reduced to NH₃. Protons required for the reduction are produced at the anode where H₂ gas is oxidised to H+, completing the anodic half of the total electrochemical reaction.

The anode (counter electrode) preferably consists of a platinised carbon catalyst on carbon paper and operates as a gas flow electrode. H₂ gas is introduced to the anode through a diffusion layer of sintered stainless steel foam. There is a layer of proton conducting Nafion™ carbon catalyst and the polymer membrane, which serves to aid in proton diffusion towards the cathode and to prevent the electrolyte from flooding the anode. Protons are delivered to the cathode via diffusion through the membrane, which is a porous polymer that has been flooded with the electrolyte. After the NH₃ is produced it is carried away from the reaction site by the flowing electrolyte and into the product separation vessel.

The catalyst (for example nanostructured iron, iron oxides or ruthenium) may be deposited on the substrate in several ways including direct electrodeposition, drop casting of catalyst/carbon/conducting-polymer slurries or oleate-mediated hydrothermal deposition. Its purpose is to provide a high density of electrochemically active sites for the reduction of dissolved N₂ molecules to ammonia.

Ideally, the cathodic substrate must be highly conductive, porous, wettable by the electrolyte when coated with the catalyst, and must have a high surface area. Examples of such substrates include carbon fibre paper, graphitic carbon felt, 3D-printed metals (iron, stainless steel, nickel etc.), sintered metal foams, stainless steel, steel or iron wool, and multilayered, metallic meshes or grids. These materials allow the unhindered flow of electrolyte to a greater or lesser extent while still providing a high internal surface area on which the catalyst may be deposited. This flow of electrolyte is important as it both delivers dissolved N₂ to the catalyst and removes NH₃ from the active sites which otherwise would hinder further NH₃ production. Once the electrolyte has left the cathode the NH₃ can be removed and the electrolyte can be recycled through the cell again. Hydrogen evolved at the cathode along with the NH3 are separated in the product separation vessel.

In a further experiment relating to the present invention, a cell was designed as described above which included a cathode of metallic iron electrodeposited on graphitic carbon felt and a Solupor™ polyethylene membrane.

A potential bias of 1V was applied between the anode and the cathode for 1 hr while an electrolyte of a ratio of 1:2 [C₄mpyr][eFAP] to trifluorotoluene was flowed through the cathode at a rate of approximately 10 mL/min. The current was measured and the N₂ gas bubbled through the electrolyte was captured by a 1 mM H₂SO₄ trap to be analysed for NH₃. The electrolyte was washed with 1 mM H₂SO₄ and the aqueous phase was also analysed using the indophenol method for ammonium determination. A rate of ammonia production of 3.2×10⁻¹¹ mol/cm²/s with a Faradaic efficiency of 5.8%.

### Example 35

In another embodiment, the liquid flow cell of Example 34 was set up such that the evolved hydrogen collected from the separation vessel was introduced into the anode hydrogen stream. This enables the hydrogen collected to be usefully consumed in the anode reaction as depicted in FIG. 11.

### Example 36

In another embodiment, the liquid flow cell of Example 34 was used with H₂O oxidation as the anode reaction. In this case, the introduced H₂ was replaced by H₂O vapour in a nitrogen stream.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A method for the electrochemical reduction of dinitrogen to ammonia, the method comprising the steps of:
(1) contacting a cathodic working electrode comprising a nanostructured catalyst with an electrolyte comprising (a) one or more liquid salts in combination with (b) one or more organic solvents having low viscosity and supporting high ionic conductivity, and
(2) introducing dinitrogen and a source of hydrogen to the electrolyte,
wherein the dinitrogen is reduced to ammonia at the cathodic working electrode.

2. The method according to claim 1, wherein the one or more liquid salts comprise a cation selected from the group comprising: ammonium, pyrrolidinium, phosphonium, and imidazolium cations.

3. (canceled)

4. The method according to claim 1, wherein the one or more liquid salts comprise an anion selected from the group comprising fluorinated borate, fluorinated phosphate, fluorinated sulphonate, fluorinated imide and fluorinated carbonate anions.

5. (canceled)

6. The method according to claim 1, wherein the electrolyte comprises a solvent selected from the group consisting of: 1,1,1,6,6,6-hexafluorohexane, methyltrifluoroacetate, ethyltrifluoroacetate, octafluorotoluene, trifluorotoluene, (2,2,2-trifluoroethoxy)pentafluorobenzene, 1,2,4,5-tetrafluorobenzene, 1,3,5-tris(trifluoromethyl)benzene, 1,3-bis(1,1,2,2-tetrafluoroethoxy)benzene, 1,3-bis(trifluoromethyl)benzene, 1-fluoro-4-(trifluoromethoxy)benzene, 2-fluorobenzotrifluoride, pentafluorobenzene, 1H, 1H,5H-octafluoropentyl 1,1,2,2-tetrafluoroethyl ether, 1,1,2,2,3,3,4-heptafluorocyclopentane, and combinations thereof.

7. The method according to claim 1 wherein the one or more liquid salts are selected from the group comprising: [C₈H₄F₁₃dmim][eFAP]; [C₈H₄F₁₃dmim][NTf₂]; [C_{2,0,1}mpyr][eFAP]; [N_{2(2,O,2,O,1)3}][B(hfip)₄]; [N_{2(2,O,2,O,1)3}][eFAP]; [P_{6,6,6,14}][C₄F₉SO₃]; [P_{6,6,6,14}][C₅F₉CO₂]; [P_{6,6,6,14}][C₆F₁₃SO₃]; [P_{4,4,4,Rf}][C₄F₉SO₃], where Rf═C₁₁H₆F₁₇; and [P_{4,4,4,Rf}][eFAP], where Rf═C₁₁H₆F₁₇ or mixtures thereof.

8. The method according to claim 1 wherein the one or more salts is a mixture of [P_{6,6,6,14}][eFAP] with [P_{6,6,6,14}][C₈F₁₇SO₃].

9. A cell for electrochemical reduction of dinitrogen to ammonia, the cell comprising:
a cathodic working electrode comprising a nanostructured catalyst for reduction of dinitrogen,
a counter electrode, and
an electrolyte comprising one or more liquid salts having low viscosity and supporting high ionic conductivity,
wherein dinitrogen introduced to the cell is reduced to ammonia at the cathodic working electrode in the presence of a source of hydrogen.

10. The cell according to claim 9 wherein the one or more liquid salts of the electrolyte comprises one or more organic solvents.

11. The cell according to claim 9, wherein the one or more liquid salts of the electrolyte comprises a cation selected from the group comprising: pyrrolidinium, phosphonium, and imidazolium cations.

12. (canceled)

13. The cell according to claim 9, wherein the one or more liquid salts of the electrolyte comprises an anion selected from the group comprising: fluorinated phosphate, fluorinated sulphonate, fluorinated imide, and fluorinated carbonate anions.

14. (canceled)

15. The cell according to claim 9, wherein the electrolyte comprises a solvent selected from the group consisting of:
1,1,1,6,6,6-hexafluorohexane, methyltrifluoroacetate, ethyltrifluoroacetate, octafluorotoluene, trifluorotoluene, (2,2,2-trifluoroethoxy)pentafluorobenzene, 1,2,4,5-tetrafluorobenzene, 1,3,5-tris(trifluoromethyl)benzene, 1,3-bis(1,1,2,2-tetrafluoroethoxy)benzene, 1,3-bis(trifluoromethyl)benzene, 1-fluoro-4-(trifluoromethoxy)benzene, 2-fluorobenzotrifluoride, 1H,1H,5H-octafluoropentyl 1,1,2,2-tetrafluoroethyl ether, 1,1,2,2,3,3,4-heptafluorocyclopentane, pentafluorobenzene, and combinations thereof.

16. The cell according to claim 9 wherein the one or more liquid salts of the electrolyte are selected from the group comprising: [C₈H₄F₁₃dmim][eFAP]; [C₈H₄F₁₃dmim][NTf₂]; [C_{2,0,1}mpyr][eFAP]; [N_{2(2,O,2,O,1)3}][B(hfip)₄]; [N_{2(2,O,2,O,1)3}][eFAP]; [P_{6,6,6,14}][C₄F₉SO₃]; [P_{6,6,6,14}][C₅F₉CO₂]; [P_{6,6,6,14}][C₆F₁₃SO₃]; [P_{4,4,4,Rf}][C₄F₉SO₃] where Rf═C₁₁H₆F₁₇; [P_{4,4,4,Rf}][eFAP], where Rf═C₁₁H₆F₁₇; and mixtures thereof.

17. The cell according to claim 9 wherein the one or more salts is a mixture of [P_{6,6,6,14}][eFAP] with [P_{6,6,6,14}][C₈F₁₇SO₃].

18. A cell for electrochemical reduction of dinitrogen to ammonia, the cell comprising:
a cathodic working electrode comprising a nanostructured catalyst for reduction of dinitrogen,
a counter electrode, and
an electrolyte comprising one or more liquid salts in contact with the working electrode, wherein the one or more liquid salts is formed by a combination of:
(i) a cation selected from the group comprising of ammonium, pyrrolidinium, phosphonium, and imidazolium cations; and
(ii) an anion selected from the group comprising of fluorinated borate, fluorinated phosphate, fluorinated sulphonate, fluorinated imide or fluorinated carbonate anions.

19. (canceled)

20. The cell according to claim 18, wherein the cation of the one or more liquid salts is selected from the group comprising: 1-(3,3,4,4,5,5,6,6,7,7,8,8,8-tridecafluorooctyl)-2,3-dimethylimidazolium, 1-(3,3,4,4,5,5,6,6,7,7,8,8,8-tridecafluorooctyl)-3-methylimidazolium, 1-ethyl-3-methylimidazolium, 1-butyl-methyl pyrrolidinium, trihexyl tetradecylphosphonium, tributyl-(4,4,5,5,6,6,7,7,8,8,9,9,10,10,11,11,11-heptadecafluoro undecyl)-phosphonium, tributyl-(3,3,4,4,5,5,6,6,7,7,8,8,8-tridecafluoroctyl) phosphonium, N-ethyl-N,N,N-tris(2-(2-methoxyethoxy)ethyl)ammonium and 1-(2-methoxyethyl)-1-methyl pyrrolidinium, 1-methyl-pyrrolidinium, 1-(4,4,5,5,6,6,7,7,8,8,9,9,10,10,11,11,11-heptadecafluoroundecyl-1-methylpyrrolidinium, and trihexyl (4,4,5,5,6,6,7,7,8,8,9,9,10,10,11,11,11-heptadecaluoroundecyl) ammonium cations.

21. (canceled)

22. The cell according to claim 18, wherein the one or more liquid salts comprises an anion selected from the group comprising: tris(pentafluoroethyl) trifluorophosphate, tris(perfluoroethyl)trifluoro phosphate, bis(trifluorosulfonyl)imide, nonafluorobutane sulfanoate, nonafluorobutane sulphonate, tridecafluorohexane sulfonate, heptadecafluorooctane sulfonate, 1,1,2,2,-tetrafluoroethane sulfonate, trifluoromethane sulphonate, nonafluoropentanoate, pentadecafluoro octanoate, and tetrakis((1,1,1,3,3,3-hexafluoropropan-2-yl)oxy)borate, tetrakis((1,1,1,3,3,3,-hexafluoropropan-2-yl)oxy) borate, and heptadecafluorononanoate anions.

23. The cell according to claim 18, wherein the electrolyte comprises a solvent selected from the group consisting of:
1,1,1,6,6,6-hexafluorohexane, methyltrifluoroacetate, ethyltrifluoroacetate, octafluorotoluene, trifluorotoluene, (2,2,2-trifluoroethoxy)pentafluorobenzene, 1,2,4,5-tetrafluorobenzene, 1,3,5-tris(trifluoromethyl)benzene, 1,3-bis(1,1,2,2-tetrafluoroethoxy)benzene, 1,3-bis(trifluoromethyl)benzene, 1-fluoro-4-(trifluoromethoxy)benzene, 2-fluorobenzotrifluoride, 1H,1H,5H-octafluoropentyl 1,1,2,2-tetrafluoroethyl ether, 1,1,2,2,3,3,4-heptafluorocyclopentane, pentafluorobenzene, and combinations thereof.

24. The cell according to claim 18 wherein the one or more liquid salts are selected from the group comprising: [C₈H₄F₃dmim][eFAP]; [C₈H₄F₁₃dmim][NTf₂]; [C_{2,0,1}mpyr][eFAP]; [N_{2(2,O,2,O,1)3}][B(hfip)₄]; [N_{2(2,O,2,O,1)3}][eFAP]; [P_{6,6,6,14}][C₄F₉SO₃]; [P_{6,6,6,14}][C₅F₉CO₂]; [P_{6,6,6,14}][C₆F₁₃SO₃]; [P_{4,4,4,Rf}][C₄F₉SO₃] where Rf═C₁₁H₆F₁₇; [P_{4,4,4,Rf}][eFAP], where Rf═C₁₁H₆F₁₇; and mixtures thereof.

25. The cell according to claim 18 wherein the one or more salts is a mixture of [P_{6,6,6,14}][eFAP] with [P_{6,6,6,14}][C₈F₁₇SO₃].
